(19) United States
(12) Patent Application Publication
(10) Pub. No.: US 2026/0267453 A1
(43) Pub. Date: Sep. 10, 2026

(54) CONDUCTIVE MEMBER FOR TOUCH PANEL, TOUCH PANEL, AND IMAGE DISPLAY DEVICE

(71) Applicant: FUJIFILM Corporation, Tokyo (JP)

(72) Inventor: Katsuyuki NUKUI, Kanagawa (JP)

(73) Assignee: FUJIFILM Corporation, Tokyo (JP)

(21) Appl. No.: 19/536,344

(22) Filed: Feb. 11, 2026

(30) Foreign Application Priority Data
Mar. 10, 2025 (JP) 2025-037678

(51) Int. Cl. G06F 3/045; G06F 3/041; G06F 3/044

(52) U.S. Cl. CPC G06F 3/045; G06F 3/041; G06F 3/04164; G06F 3/0445; G06F 3/0446

(57) ABSTRACT

The present invention provides a conductive member for a touch panel, a touch panel, and an image display device, which suppress cracking or disconnection at the time of connecting an external connection terminal and a flexible substrate, and further suppress cracking or disconnection of an external connection terminal caused by peeling charging.

The conductive member for a touch panel includes a substrate and a conductive layer disposed on at least one surface of the substrate. The conductive layer includes a plurality of detection electrodes, a plurality of lead wires led out from the plurality of detection electrodes, and a plurality of external connection terminals connected to the plurality of lead wires. The external connection terminal has a first structure part disposed on a lead wire side and a second structure part electrically connected to the first structure part. The first structure part has a pattern formed by a wire which forms an angle with an extending direction of the external connection terminal. In a case where a height of the lead wire is indicated as A, a height of the first structure part is indicated as B, and a height of the second structure part is indicated as C, B<A<C is satisfied.

### CROSS-REFERENCE TO RELATED APPLICATIONS

The present application claims priority under 35 U.S.C. § 119 to Japanese Patent Application No. 2025-037678, filed on Mar. 10, 2025. The above application is hereby expressly incorporated by reference, in its entirety, into the present application.

### BACKGROUND OF THE INVENTION

### 1. Field of the Invention

The present invention relates to a conductive member for a touch panel, which includes a plurality of detection electrodes, a lead wire, and an external connection terminal, a touch panel, and an image display device.

### 2. Description of the Related Art

In various electronic apparatuses including portable information apparatus such as a tablet computer and a smartphone, there is a touch panel which is used in combination with an image display device such as a liquid crystal display device and with which an input operation to an electronic apparatus is carried out by bringing a finger, a stylus pen, or the like into touch or a close contact to a screen.

In the touch panel, a conductive member for the touch panel, on which a plurality of detection electrodes and the like for detecting the touch operation with a finger, a stylus pen, or the like are formed, is usually used as a touch sensor.

For example, JP2023-079370A discloses a conductive member for a touch panel, including a substrate and a conductive layer disposed on at least one surface of the substrate, in which the conductive layer includes a plurality of detection electrodes, a plurality of lead wires led out from the plurality of detection electrodes, and a plurality of external connection terminals connected to the plurality of lead wires, and a ratio D1/D2 of a thickness D1 of the external connection terminal to a thickness D2 of the lead wire satisfies 1.00<D1/D2≤3.00.

### SUMMARY OF THE INVENTION

The external connection terminal of the conductive member for a touch panel is, for example, pressure-bonded to a flexible substrate (FPC) through an anisotropic conductive film (ACF), and the external connection terminal and the flexible substrate are electrically connected to each other. In a case where the external connection terminal, an anisotropic conductive film, and the flexible substrate are pressure-bonded to each other, the external connection terminal may be cracked or disconnected.

In addition, the conductive member for a touch panel may overlap the external connection terminal by winding the conductive member for a touch panel in a roll shape, or by laminating the conductive member for a touch panel. In a case where the conductive member for a touch panel is peeled off from this state, a so-called peeling charging occurs, and a spark current is generated. The spark current flows into the lead wire through the external connection terminal, and the lead wire may be cracked or disconnected.

The cracking or disconnection of the lead wire caused by the above-described peeling charging is referred to as a spark failure.

In the conductive member for a touch panel of JP2023-079370A, the above-described cracking or disconnection at the time of connecting the external connection terminal and the flexible substrate is suppressed. However, sufficient measures have not been taken against the above-described spark failure.

An object of the present invention is to provide a conductive member for a touch panel, a touch panel, and an image display device, which suppress cracking or disconnection at the time of connecting an external connection terminal and a flexible substrate, and further suppress cracking or disconnection of an external connection terminal caused by peeling charging.

The above-described object can be achieved by the following configurations.

An invention [1] is a conductive member for a touch panel, including a substrate and a conductive layer disposed on at least one surface of the substrate, in which the conductive layer includes a plurality of detection electrodes, a plurality of lead wires led out from the plurality of detection electrodes, and a plurality of external connection terminals connected to the plurality of lead wires, the external connection terminal has a first structure part disposed on a lead wire side and a second structure part electrically connected to the first structure part, the first structure part has a pattern formed by a wire which forms an angle with an extending direction of the external connection terminal, and in a case where a height of the lead wire is indicated as A, a height of the first structure part is indicated as B, and a height of the second structure part is indicated as C, B<A<C is satisfied.

An invention [2] is a conductive member for a touch panel, including a substrate and a conductive layer disposed on at least one surface of the substrate, in which the conductive layer includes a plurality of detection electrodes, a plurality of lead wires led out from the plurality of detection electrodes, and a plurality of external connection terminals connected to the plurality of lead wires, the external connection terminal has a first structure part disposed on a lead wire side and a second structure part electrically connected to the first structure part, the first structure part includes a plurality of wirings arranged side by side in a width direction orthogonal to an extending direction of the external connection terminal, each wiring having a first curve which protrudes to a first orientation in the width direction and a second curve which protrudes to a second orientation opposite to the first orientation, the curves being alternately arranged along the extending direction, and the wirings being in contact with adjacent wirings in the width direction, and in a case where a height of the lead wire is indicated as A, a height of the first structure part is indicated as B, and a height of the second structure part is indicated as C, B<A<C is satisfied.

An invention [3] is the conductive member for a touch panel according to the invention [2], in which a first curve and a second curve of the first structure part are formed by a circular arc, a parabolic curve, or a curve represented by a periodic function.

An invention [4] is the conductive member for a touch panel according to any one of the inventions [1] to [3], in which the first structure part has a mesh-like wiring pattern.

An invention [5] is the conductive member for a touch panel according to any one of the inventions [1] to [4], in which the height A of the lead wire, the height B of the first structure part, and the height C of the second structure part satisfy 0.7<A/C<1.0 and 0.25<B/C<0.7.

An invention [6] is the conductive member for a touch panel according to any one of the inventions [1] to [5], in which a proportion of a length of the first structure part in the extending direction to a length of the external connection terminal in the extending direction is 25% or more.

An invention [7] is a touch panel including the conductive member for a touch panel according to any one of the inventions [1] to [6].

An invention [8] is an image display device including the conductive member for a touch panel according to any one of the inventions [1] to [6], and an image display element.

According to the present invention, it is possible to provide a conductive member for a touch panel, a touch panel, and an image display device, which suppress cracking or disconnection at the time of connecting an external connection terminal and a flexible substrate, and further suppress cracking or disconnection of an external connection terminal caused by peeling charging.

### BRIEF DESCRIPTION OF THE DRAWINGS

FIG. 1 is a schematic cross-sectional view showing an example of an image display device according to the embodiment of the present invention.

FIG. 2 is a schematic view showing an example of a touch sensor film including a conductive member for a touch panel according to the embodiment of the present invention.

FIG. 3 is a schematic view showing an example of a configuration of a detection electrode of the conductive member for a touch panel according to the embodiment of the present invention.

FIG. 4 is a schematic view showing a first example of an external connection terminal of the conductive member for a touch panel according to the embodiment of the present invention.

FIG. 5 is a schematic view showing a first structure part of the first example of the external connection terminal in the conductive member for a touch panel according to the embodiment of the present invention.

FIG. 6 is a schematic view showing a state in which the first structure part of the first example of the external connection terminal in the conductive member for a touch panel according to the embodiment of the present invention is bent.

FIG. 7 is a schematic view for describing a state in which an external connection terminal in the related art is bent.

FIG. 8 is a schematic view for describing a state in which the external connection terminal in the related art is bent.

FIG. 9 is a schematic view showing an example of a connection between the external connection terminal in the conductive member for a touch panel according to the embodiment of the present invention and a flexible substrate.

FIG. 10 is a schematic view showing a relationship between a height of a lead wire, a height of the first structure part, and a height of the second structure part in the external connection terminal of the conductive member for a touch panel according to the embodiment of the present invention.

FIG. 11 is a schematic view showing a modification example of the first example of the external connection terminal in the conductive member for a touch panel according to the embodiment of the present invention.

FIG. 12 is a schematic view showing a second example of the external connection terminal in the conductive member for a touch panel according to the embodiment of the present invention.

FIG. 13 is a schematic view showing a first structure part of the second example of the external connection terminal in the conductive member for a touch panel according to the embodiment of the present invention.

FIG. 14 is a schematic view showing a third example of the external connection terminal in the conductive member for a touch panel according to the embodiment of the present invention.

FIG. 15 is a schematic view showing a first structure part of the third example of the external connection terminal in the conductive member for a touch panel according to the embodiment of the present invention.

FIG. 16 is a schematic view showing a state in which the first structure part of the third example of the external connection terminal in the conductive member for a touch panel according to the embodiment of the present invention is bent.

FIG. 17 is a schematic view showing an external connection terminal at a level 1.

FIG. 18 is a schematic view showing an external connection terminal at a level 2.

FIG. 19 is a schematic view showing an external connection terminal at a level 3.

### DESCRIPTION OF THE PREFERRED EMBODIMENTS

Hereinafter, the conductive member for a touch panel, the touch panel, and the image display device according to the embodiments of the present invention will be described in detail based on suitable embodiments illustrated in the attached drawings.

The drawings described below are exemplary for explaining the present invention, and the present invention is not limited to the drawings illustrated below.

In the following, “to” indicating the numerical range includes numerical values described on both sides. For example, in a case where ε is a numerical value ε_{α} to a numerical value ε_{β}, the range of ε is a range including the numerical value ε_{α} and the numerical value ε_{β}, and in mathematical symbols, ε_{α}≤ε≤ε_{β}.

Unless specified otherwise, the meaning of an angle such as “an angle represented by a specific numerical value”, “parallel”, and “orthogonal” includes a case where an error range is generally allowable in the technical field.

“Transparency” refers to that a light transmittance is 40% or more in a visible light wavelength range of 380 to 780 nm, unless otherwise specified, where the light transmittance is preferably 80% or more and more preferably 90% or more.

The light transmittance is measured using “Plastics-Determination of total light transmittance and reflectance” specified in Japanese Industrial Standards (JIS) K 7375:2008.

### Image Display Device

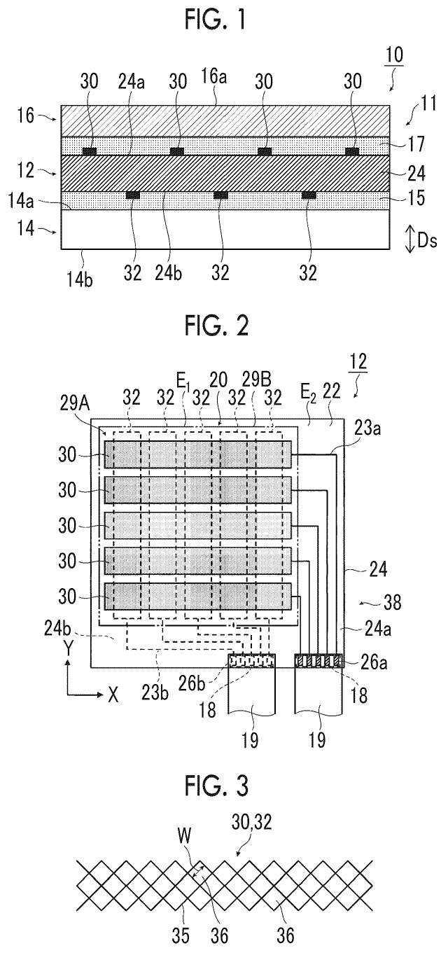

FIG. 1 is a schematic cross-sectional view showing an example of the image display device according to the embodiment of the present invention.

An image display device 10 shown in FIG. 1 includes a conductive member 12 for a touch panel, an image display unit 14, a first transparent insulation layer 15, a cover part 16, and a second transparent insulation layer 17. In the image display device 10, the image display unit 14, the first transparent insulation layer 15, the conductive member 12 for a touch panel, the second transparent insulation layer 17, and the cover part 16 are laminated in this order in a lamination direction Ds, and the conductive member 12 for a touch panel is disposed on a display surface 14a side of the image display unit 14.

In the image display device 10, the conductive member 12 for a touch panel and the image display unit 14 are laminated through the first transparent insulation layer 15. The conductive member 12 for a touch panel and the cover part 16 are laminated through the second transparent insulation layer 17.

The first transparent insulation layer 15 is provided on an entire region of the display surface 14a of the image display unit 14. For example, the first transparent insulation layer 15 and the second transparent insulation layer 17 are provided in the same region. Therefore, in a case of being viewed from a front surface 16a side of the cover part 16, the first transparent insulation layer 15 and the second transparent insulation layer 17 have the same size.

In the image display device 10, it is preferable that the first transparent insulation layer 15, the conductive member 12 for a touch panel, the second transparent insulation layer 17, and the cover part 16, which are arranged on the display surface 14a side of the image display unit 14 such that a displayed object (not shown) displayed on the display surface 14a of the image display unit 14 is visible, are transparent.

In the image display device 10, the front surface 16a of the cover part 16 is a touch surface of the image display device 10, and serves as an operation surface. In the image display device 10, the front surface 16a of the cover part 16 is operated as an operation surface. The touch surface is a surface which detects contact with a finger, a stylus pen, or the like. The front surface 16a of the cover part 16 serves as a visible surface of the displayed object (not shown) displayed on the display surface 14a of the image display unit 14.

In the image display device 10, for example, a controller (not shown) is provided on a back surface 14b of the image display unit 14. A first external connection terminal 26a (see FIG. 2) and a second external connection terminal 26b (see FIG. 2) of the conductive member 12 for a touch panel, and the controller are electrically connected to each other by, for example, a wiring member having flexibility, such as a flexible substrate 19 (see FIG. 2).

For example, a touch panel 11 is configured by the conductive member 12 for a touch panel, the second transparent insulation layer 17, the cover part 16, and the controller (not shown). The touch panel 11 includes the conductive member 12 for a touch panel.

The controller is configured by a known controller used for detecting the contact of the finger, the stylus pen, or the like described above. In a case where the image display device 10 is of a capacitance type, the controller detects a position where the capacitance is changed by contact with the finger or the like on the front surface 16a of the cover part 16 which serves as a touch surface. Examples of the capacitance type touch panel include a mutual capacitance type touch panel and a self-capacitance type touch panel, but the capacitance type touch panel is not particularly limited thereto.

The cover part 16 protects the conductive member 12 for a touch panel. A configuration of the cover part 16 is not particularly limited. The cover part 16 is preferably transparent so that the displayed object (not shown) displayed on the display surface 14a of the image display unit 14 can be visible. For the cover part 16, for example, a plastic film, a plastic plate, a glass plate, or the like is used. It is preferable that a thickness of the cover part 16 is appropriately selected according to each use application.

As raw materials for the above-described plastic film and plastic plate, for example, the following materials can be used: polyesters such as polyethylene terephthalate (PET) and polyethylene naphthalate (PEN); polyolefins such as polyethylene (PE), polypropylene (PP), polystyrene, and vinyl acetate copolymerized polyethylene (EVA); vinyl resins; and other materials such as a polycarbonate (PC), polyamide, polyimide, an acrylic resin, triacetyl cellulose (TAC), a cycloolefin-based resin (COP), polyvinylidene fluoride (PVDF), polyarylate (PAR), polyether sulfone (PES), a high-molecular-weight acrylic resin, a fluorene derivative, and crystalline COP.

In addition, as the cover part 16, a polarizing plate, a circularly polarizing plate, or the like may be used.

Since the front surface 16a of the cover part 16 serves as a touch surface as described above, a hard coat layer may be provided on the front surface 16a as necessary. A thickness of the cover part 16 is, for example, 0.1 to 1.3 mm, particularly preferably 0.1 to 0.7 mm.

A configuration of the first transparent insulation layer 15 is not particularly limited as long as it is transparent, has electrical insulating properties, and can stably fix the conductive member 12 for a touch panel and the image display unit 14. As the first transparent insulation layer 15, it is possible to use, for example, an optical clear resin (OCR) such as an optical clear adhesive (OCA) and an ultra violet (UV) curing resin. In addition, the first transparent insulation layer 15 may be partially hollow.

In addition, a configuration of the second transparent insulation layer 17 is not particularly limited as long as it is transparent, has electrical insulating properties, and can stably fix the conductive member 12 for a touch panel and the cover part 16. As the second transparent insulation layer 17, the same one as the first transparent insulation layer 15 can be used.

The image display unit 14 is an image display unit having the display surface 14a for displaying the displayed object such as an image, and is, for example, a liquid crystal display device. The image display unit 14 is not limited to the liquid crystal display device, and an organic electroluminescence (EL) display device, electronic paper, or the like can be used.

The image display unit 14 is appropriately used according to the application, but is preferably in a form of a panel such as a liquid crystal display panel, an organic EL panel, and electronic paper in order to reduce the thickness of the image display device 10.

### Conductive Member for Touch Panel

The conductive member 12 for a touch panel will be described with reference to FIG. 2. FIG. 2 is a schematic view showing an example of a touch sensor film including the conductive member for a touch panel according to the embodiment of the present invention; and FIG. 3 is a schematic view showing an example of a configuration of a detection electrode of the conductive member for a touch panel according to the embodiment of the present invention. In FIG. 2 and FIG. 3, the same reference numerals are assigned to the same configuration components as those in the image display device 10 shown in FIG. 1, and the detailed description thereof will not be repeated.

The conductive member 12 for a touch panel shown in FIG. 2 is a portion which functions as a touch sensor of the touch panel 11 (see FIG. 1), and includes a detection unit 20 which is a detection region E₁ in which an input operation can be performed by a user, and a peripheral wiring part 22 which is a peripheral region E₂ located outside of the detection region E₁.

The detection unit 20 has, for example, a first detection electrode layer 29A and a second detection electrode layer 29B. The first detection electrode layer 29A and the second detection electrode layer 29B are arranged, for example, with a substrate 24 being sandwiched therebetween. The substrate 24 functions as an electrically insulating layer. The first detection electrode layer 29A and the second detection electrode layer 29B are electrically insulated from each other by the substrate 24. In addition, the substrate 24 electrically insulates a first lead wire 23a and a first external connection terminal 26a, which will be described later, from a second lead wire 23b and a second external connection terminal 26b, which will be described later.

The first detection electrode layer 29A includes a plurality of first detection electrodes 30. The plurality of first detection electrodes 30 are strip-shaped electrodes which extend in an X direction in parallel with each other, and are provided on a front surface 24a of the substrate 24 (see FIG. 1) in a state of being spaced apart from each other in a Y direction orthogonal to the X direction and being electrically insulated from each other in the Y direction.

It is preferable that a dummy electrode (not shown) which is electrically insulated from the first detection electrode 30 is disposed between the first detection electrodes 30.

The second detection electrode layer 29B includes a plurality of second detection electrodes 32. The plurality of second detection electrodes 32 are strip-shaped electrodes which extend in the Y direction in parallel with each other, and are provided on a back surface 24b of the substrate 24 (see FIG. 1) in a state of being spaced apart from each other in the X direction and being electrically insulated from each other in the X direction.

It is preferable that a dummy electrode (not shown) which is electrically insulated from the second detection electrode 32 is disposed between the second detection electrodes 32.

The plurality of first detection electrodes 30 and the plurality of second detection electrodes 32 are provided to be orthogonal to each other, but are electrically insulated from each other by the substrate 24 as described above.

As shown in FIG. 2, five first detection electrodes 30 and five second detection electrodes 32 are provided in the detection unit 20, but the numbers thereof are not particularly limited as long as they are plural.

An electrode width of the first detection electrode 30 and an electrode width of the second detection electrode 32 are each, for example, 1 to 5 mm, and a pitch between the electrodes is 3 to 6 mm. The electrode width of the first detection electrode 30 is denoted as the maximum length in the Y direction, and the electrode width of the second detection electrode 32 is denoted as the maximum length in the X direction.

The first detection electrode 30 and the second detection electrode 32 are configured of, for example, a metal wire 35 as shown in FIG. 3. The dummy electrode is also configured in a mesh pattern by, for example, the metal wire 35.

The peripheral wiring part 22 is a region in which the first lead wire 23a and the second lead wire 23b, which are peripheral wirings for transmitting or propagating a touch drive signal and a touch detection signal to the first detection electrode 30 and the second detection electrode 32 from the controller (not shown), are disposed. A plurality of the first lead wires 23a and a plurality of the second lead wires 23b are arranged in the peripheral wiring part 22. One end of the first lead wire 23a is electrically connected to the first detection electrode 30 through an electrode terminal (not shown), and the other end is electrically connected to the first external connection terminal 26a. In addition, one end of the second lead wire 23b is electrically connected to the second detection electrode 32 through an electrode terminal (not shown), and the other end is electrically connected to the second external connection terminal 26b.

The flexible substrate 19 is electrically connected to each of the first external connection terminal 26a and the second external connection terminal 26b in the conductive member 12 for a touch panel through an anisotropic conductive film 18. A touch sensor film 38 is configured by the conductive member 12 for a touch panel, the anisotropic conductive film 18, and the flexible substrate 19.

The first lead wire 23a and the second lead wire 23b can also have the same configuration as the first detection electrode 30 and the second detection electrode 32, and are configured of, for example, the metal wire 35.

The electrode terminal may have a spread film shape, that is, a solid film shape, or may have a mesh shape as shown in JP2013-127658A. A preferred range of a width of the electrode terminal is ⅓ times or more and 1.2 times or less of the electrode width of the first detection electrode 30 or the second detection electrode 32.

From the viewpoint of electrical resistance, difficulty of disconnection, and the like, the dummy electrode, the electrode terminal, the first lead wire 23a, and the second lead wire 23b are preferably integrally configured, and more preferably formed of the same metal material.

### External Connection Terminal

The conductive member 12 for a touch panel has a configuration in which the first external connection terminal 26a and the second external connection terminal 26b are provided as external connection terminals.

Since the first external connection terminal 26a and the second external connection terminal 26b have the same configuration, hereinafter, in the description of examples of the external connection terminal, the first external connection terminal 26a will be described and the description of the second external connection terminal 26b will be omitted.

### First Example of External Connection Terminal

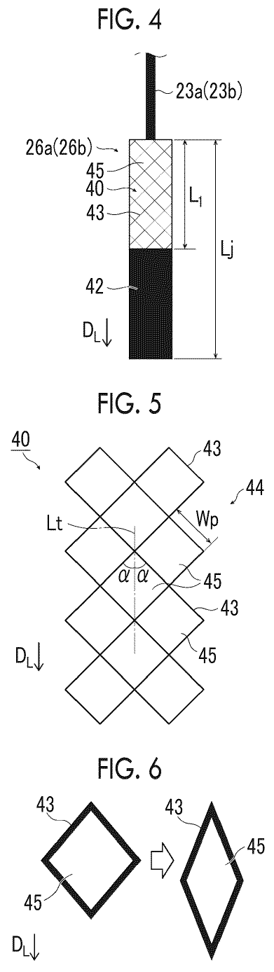

FIG. 4 is a schematic view showing a first example of the external connection terminal in the conductive member for a touch panel according to the embodiment of the present invention; and FIG. 5 is a schematic view showing a first structure part of the first example of the external connection terminal in the conductive member for a touch panel according to the embodiment of the present invention.

In FIG. 4 and FIG. 5, the same reference numerals are assigned to the same configuration components as those in the image display device 10 shown in FIG. 1, and the detailed description thereof will not be repeated.

The first external connection terminal 26a has conductivity, and an outer shape thereof is, for example, a rectangular shape extending in one direction. A direction in which the first external connection terminal 26a extends is an extending direction D_{L}. In a case where the first external connection terminal 26a has a rectangular shape extending in one direction, a direction in which a long side extends is the extending direction D_{L}.

The first external connection terminal 26a has a first structure part 40 which is disposed on the first lead wire 23a side, and a second structure part 42 which is electrically connected to the first structure part 40. The first external connection terminal 26a has a configuration in which the first structure part 40 and the second structure part 42 are continuously connected in the extending direction D_{L}. The second structure part 42 is configured of, for example, a surface-shaped film called a solid film.

The first structure part 40 has, for example, a pattern 44 formed by a wiring 43 which forms an angle α with the extending direction D_{L} of the first external connection terminal 26a as shown in FIG. 5. The pattern 44 of the first structure part 40 is a mesh-like wiring pattern. A shape of an opening portion 45 shown in FIG. 5 is a rhombus, and a length Wp of one side of the rhombic opening portion 45 is a mesh pitch.

The mesh of the mesh-like wiring pattern is intended to be a shape including a plurality of opening portions 45 configured by the intersecting wirings 43. The wiring 43 is formed of, for example, the same metal material as the above-described metal wire 35 (see FIG. 3).

In a case where the shape of the opening portion 45 formed by the wiring 43 in the first structure part 40 is a rhombus, it is estimated that, in a case where a force is applied in the extending direction D_{L} as shown in FIG. 6, the opening portion 45 is deformed to follow tensile deformation of the opening portion 45, so that the elongation of the wiring 43 is relaxed, and the wiring 43 is not broken, and thus the wiring 43 is difficult to be broken. Therefore, in a case where the first external connection terminal 26a is bent such that the second structure part 42 is lowered, the wiring 43 is difficult to be disconnected, and thus the shape of the opening portion 45 is preferably a rhombus. In a case where the first external connection terminal 26a is bent such that the second structure part 42 is lowered, the rhombic opening portion 45 is more preferably disposed such that two vertices facing each other are located on a line Lt parallel to the extending direction D_{L} as a configuration in which the wiring 43 is further difficult to be disconnected.

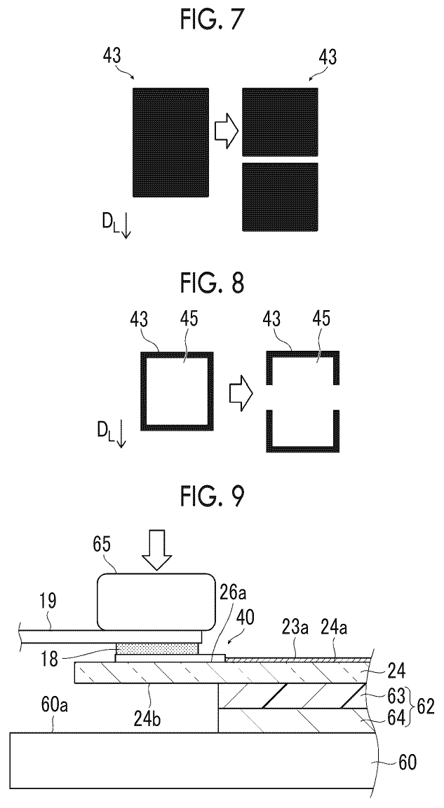

In a case where the wiring 43 has a configuration of a surface-shaped film called a solid film as shown in FIG. 7, it is estimated that, in a case where a force is applied in the extending direction D_{L}, the wiring 43 is cracked or the wiring 43 is broken in a case where the tensile deformation of the wiring 43 exceeds the limit of a tensile strength of the wiring 43.

In addition, in a case where a force is applied in the extending direction D_{L} to the opening portion 45 having the wiring 43 extending in the extending direction D_{L} as shown in FIG. 8, a tensile force is applied to the wiring 43 parallel to the extending direction D_{L} in the wiring 43 of the opening portion 45. It is estimated that, in a case where the tensile force exceeds the limit of the tensile strength of the wiring 43, the wiring 43 is cracked or the wiring 43 is broken in a case where the wiring 43 cannot withstand the tensile force.

It is preferable that an interior angle of the opening portion 45 is bisected by the above-described parallel line Lt. As a result, the opening portion 45 is line-symmetrical with respect to the parallel line Lt, that is, the extending direction D_{L}. In such a configuration, in a case where a force is applied in the extending direction D_{L}, the opening portion 45 is deformed without an imbalance in the force applied to the wiring 43, so that the wiring 43 is less likely to be cracked or broken.

In the first external connection terminal 26a, a proportion of a length L₁ of the first structure part 40 in the extending direction D_{L} to a length Lj of the first external connection terminal 26a in the extending direction D_{L} is preferably 25% or more. The upper limit of the above-described proportion of the length L₁ of the first structure part 40 in the extending direction D_{L} is, for example, 75%. The above-described proportion of the length L₁ of the first structure part 40 in the extending direction D_{L} is more preferably 25% to 50%.

The length Lj of the first external connection terminal 26a in the extending direction D_{L} and the length L₁ of the first structure part 40 in the extending direction D_{L} are measured as follows. First, an optical microscope image of the first external connection terminal 26a is acquired with an optical microscope. Next, a region corresponding to the first external connection terminal 26a and a region corresponding to the first structure part 40 are specified in the optical microscope image. A length of the specified region corresponding to the first external connection terminal 26a is measured, and this length is defined as the length Lj of the first external connection terminal 26a. A length of the region corresponding to the first structure part 40 is measured, and this length is defined as the length L₁ of the first structure part 40.

In order to electrically connect the first external connection terminal 26a and the flexible substrate 19, for example, as shown in FIG. 9, an adhesive sheet 62 having an adhesive layer 63 and a release paper 64 is provided on the back surface 24b of the substrate 24 of the conductive member 12 for a touch panel and is disposed on a stage 60. The adhesive layer 63 of the adhesive sheet 62 is bonded to the back surface 24b of the substrate 24, but the adhesive sheet 62 is not provided on the back surface 24b opposite to the first external connection terminal 26a. A level difference is present between the first external connection terminal 26a and the stage 60.

The anisotropic conductive film 18 is laminated on the first external connection terminal 26a, and the flexible substrate 19 is laminated on the anisotropic conductive film 18. In this state, the flexible substrate 19 is pressed against a heating and pressing head 65, and the first external connection terminal 26a, the anisotropic conductive film 18, and the flexible substrate 19 are heated under pressure. As a result, the flexible substrate 19 is electrically connected to the first external connection terminal 26a through the anisotropic conductive film 18. In this case, since the adhesive sheet 62 is not provided on the back surface 24b of the first external connection terminal 26a, the first external connection terminal 26a is bent to a front surface 60a side of the stage 60, and a force is applied to the first external connection terminal 26a in the extending direction D_{L}. That is, a tensile force is applied to the first external connection terminal 26a in the extending direction D_{L}. In this case, in a case where the shape of the opening portion 45 of the first structure part 40 is a rhombus, the breakage of the wiring 43 is suppressed as described above. On the other hand, in a case where the external connection terminal is the solid film as shown in FIG. 7, or in a case where the wiring 43 extending in the extending direction D_{L} as the opening portion 45 of FIG. 8 is provided, the wiring 43 is likely to be broken in a case where a force is applied in the extending direction D_{L}. Therefore, in the first structure part 40, by having the pattern 44 formed by the wiring 43 which forms the angle α with the extending direction D_{L} of the first external connection terminal 26a, the cracking of the wiring or the disconnection of the wiring can be suppressed at the time of connecting the first external connection terminal 26a and the flexible substrate 19.

In the external connection terminal, in a case where a height of the lead wire is indicated as A, a height of the first structure part is indicated as B, and a height of the second structure part is indicated as C, B<A<C is satisfied.

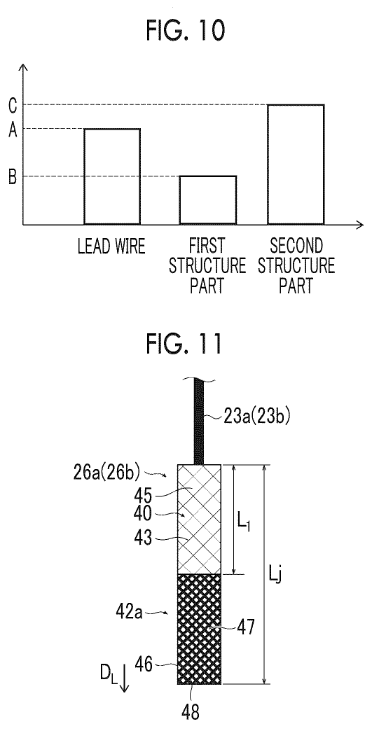

Here, FIG. 10 is a schematic view showing a relationship between the height of the lead wire, the height of the first structure part, and the height of the second structure part in the external connection terminal of the conductive member for a touch panel according to the embodiment of the present invention. FIG. 10 schematically shows a relationship between the height of the lead wire, the height of the first structure part, and the height of the second structure part in the external connection terminal.

A relationship between the height of the first lead wire 23a, the height of the first structure part 40 of the first external connection terminal 26a, and the height of the second structure part 42 of the first external connection terminal 26a is shown in FIG. 10.

In the external connection terminal, in a case where B<A<C is satisfied as described above, the height C of the second structure part 42 is high, and the height B of the first structure part 40 is low. With regard to the spark failure, in a case of laminating the conductive member 12 for a touch panel, the contact of the second structure part 42 occurs more favorably than the contact of the first structure part 40 because the height of the pattern in the second structure part 42 is high. Therefore, in a case of laminating the conductive member 12 for a touch panel, a contact area of the first structure part 40 is reduced. Therefore, it is estimated that the peeling charging at the time of peeling off the conductive member 12 for a touch panel is reduced, and thus the frequency of occurrence of the spark failure is reduced.

In addition, it is estimated that the first structure part 40 present between the second structure part 42 of the external connection terminal and the lead wire contributes to reducing the spark failure.

The height A of the first lead wire 23a, the height B of the first structure part 40 of the first external connection terminal 26a, and the height C of the second structure part 42 of the first external connection terminal 26a preferably satisfy B<A<C, and further satisfy 0.7<A/C<1.0 and 0.25<B/C<0.7.

The height A of the lead wire is measured as follows. First, in the conductive member 12 for a touch panel, the substrate 24 on which the lead wire is disposed is cut in the thickness direction to expose a cross section. The exposed cross section is imaged using a scanning electron microscope (SEM) to acquire a cross-sectional image. Next, in the cross-sectional image including the lead wire, 10 portions corresponding to the lead wire are randomly selected. Lengths of the selected 10 portions are measured, and an average value of the lengths of the 10 portions is defined as the height A of the lead wire.

The height B of the first structure part is measured as follows. First, in the conductive member 12 for a touch panel, the substrate 24 on which the external connection terminal is disposed is cut in the thickness direction to expose a cross section. The exposed cross section is imaged using a scanning electron microscope (SEM) to acquire a cross-sectional image. Next, in the cross-sectional image including the external connection terminal, 10 portions corresponding to the first structure part are randomly selected. Lengths of the selected 10 portions are measured, and an average value of the lengths of the 10 portions is defined as the height B of the first structure part.

The first structure part has a pattern formed by the wiring as described above. The wiring portion is a portion corresponding to the above-described first structure part, and a height of the wiring portion is the height of the first structure part. Therefore, in a case of measuring the height of the first structure part, a portion other than the wiring portion is not selected.

The height C of the second structure part is measured as follows. First, in the conductive member 12 for a touch panel, the substrate 24 on which the external connection terminal is disposed is cut in the thickness direction to expose a cross section. The exposed cross section is imaged using a scanning electron microscope (SEM) to acquire a cross-sectional image. Next, in the cross-sectional image including the external connection terminal, 10 portions corresponding to the second structure part are randomly selected. Lengths of the selected 10 portions are measured, and an average value of the lengths of the 10 portions is defined as the height C of the second structure part.

In a case where the second structure part is configured of a surface-shaped film called the solid film as described above, a height of the solid film portion is the height of the second structure part.

In a case where the second structure part has a mesh-like wiring pattern as described later, a height of the wiring pattern portion is the height of the second structure part. Therefore, in a case where the second structure part has a mesh-like wiring pattern as described later, the wiring pattern portion is a portion corresponding to the second structure part. Therefore, in a case of measuring the height of the second structure part, a portion other than the wiring pattern portion is not selected.

In the first external connection terminal 26a, the configuration of the second structure part 42 is a surface-shaped film called a solid film, but the present invention is not limited thereto.

The second structure part 42 may also have a configuration including the pattern 44 formed by the wiring 43 which forms the angle α with the extending direction D_{L} of the first external connection terminal 26a as shown in FIG. 5.

More specifically, a second structure part 42a may have a configuration including a pattern 47 formed of a wiring 46 as shown in FIG. 11, and for example, a plurality of opening portions 48 are configured by intersecting wirings 46. A shape of the opening portion 48 is, for example, the same as the shape of the opening portion 45 shown in FIG. 5. The second structure part 42a has a mesh-like wiring pattern.

In the second structure part 42a, from the viewpoint of increasing the conductivity, a width of the wiring 46 is preferably larger than a width of the wiring 43 of the first structure part 40. In addition, an opening ratio of the second structure part 42a is preferably smaller than an opening ratio of the first structure part 40. By making the opening ratio of the second structure part 42a smaller than the opening ratio of the first structure part 40, connectivity between the first external connection terminal 26a and the flexible substrate 19 is improved.

Here, the opening ratio is a proportion (%) of a transmissive portion excluding the wiring in the region of the first structure part 40 in a case of the first structure part 40, and corresponds to a proportion (%) of the opening portion in the entire region of the first structure part 40.

In addition, the opening ratio is a proportion (%) of a transmissive portion excluding the wiring in the region of the second structure part 42 in a case of the second structure part 42, and corresponds to a proportion (%) of the opening portion in the entire region of the second structure part 42.

For the opening ratio, in a case of the first structure part 40, first, an optical microscope image of the first external connection terminal 26a is acquired with an optical microscope. Next, a region corresponding to the first structure part 40 is specified in the optical microscope image, and the wiring in the region corresponding to the first structure part 40 is specified. An area S₁ of the region corresponding to the first structure part 40 and an area S₁₂ of a portion corresponding to the wiring in the region corresponding to the first structure part 40 are obtained. Next, the opening ratio is obtained using the following expression of the opening ratio (%).

$$Opening ratio ( \% ) = ( ( {S}_{1} - {S}_{12} ) / {S}_{1} ) \times 100$$

Even in a case of the second structure part 42, as in the first structure part 40, first, an optical microscope image of the first external connection terminal 26a is acquired with an optical microscope. Next, a region corresponding to the second structure part 42 is specified in the optical microscope image, and the wiring in the region corresponding to the second structure part 42 is specified. An area S₂ of the region corresponding to the second structure part 42 and an area S₂₂ of a portion corresponding to the wiring in the region corresponding to the second structure part 42 are obtained. Next, the opening ratio is obtained using the following expression of the opening ratio (%).

$$Opening ratio ( \% ) = ( ( {S}_{2} - {S}_{22} ) / {S}_{2} ) \times 100$$

In the second external connection terminal 26b, the opening ratio of the first structure part and the opening ratio of the second structure part can be obtained in the same manner as in the first external connection terminal 26a described above.

### Second Example of External Connection Terminal

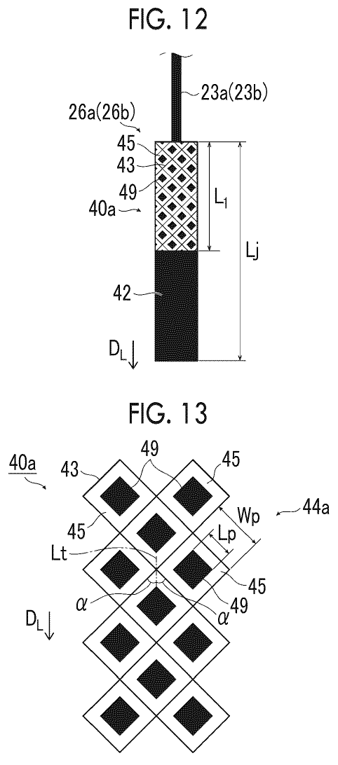

FIG. 12 is a schematic view showing a second example of the external connection terminal in the conductive member for a touch panel according to the embodiment of the present invention; and FIG. 13 is a schematic view showing a first structure part of the second example of the external connection terminal in the conductive member for a touch panel according to the embodiment of the present invention.

In FIG. 12 and FIG. 13, the same reference numerals are assigned to the same configuration components as those in the first external connection terminal 26a shown in FIG. 4 and the first structure part 40 shown in FIG. 5, and the detailed description thereof will not be repeated.

The second example of the first external connection terminal 26a shown in FIG. 12 is different from the first external connection terminal 26a shown in FIG. 4 in that a configuration of a first structure part 40a is different, and the other configurations are the same as the configurations of the first external connection terminal 26a shown in FIG. 4.

The first structure part 40a of the first external connection terminal 26a shown in FIG. 12 has a pattern 44a in which a non-conductive portion 49 is disposed in the opening portion 45 of the first structure part 40 of the first external connection terminal 26a shown in FIG. 5.

As shown in FIG. 5, for example, an outer shape of the non-conductive portion 49 is similar to the outer shape of the opening portion 45 and is a rhombus. In the first structure part 40a, as shown in FIG. 5, the non-conductive portion 49 is disposed in the opening portion 45 with the outer shape of the non-conductive portion 49 and the outer shape of the opening portion 45 corresponding to each other.

The non-conductive portion 49 is not electrically connected to the first external connection terminal 26a and the first lead wire 23a, and is electrically insulated.

The non-conductive portion 49 is formed of, for example, a metal. The non-conductive portion 49 is formed of, for example, the same metal material as the wiring 43 of the first structure part 40. Therefore, the non-conductive portion 49 can be formed in the same step as the wiring 43 and the opening portion 45 in a case of forming the first external connection terminal 26a.

In the second example of the first external connection terminal 26a, by providing the non-conductive portion 49, a surface pressure applied from the laminated conductive member 12 for a touch panel to the first external connection terminal 26a is dispersed to the non-conductive portion 49, the surface pressure applied to the first structure part 40a is reduced, and thus the peeling charging is suppressed. As a result, the spark failure caused by the spark current flowing into the lead wire through the first external connection terminal 26a is suppressed.

As described above, by providing the non-conductive portion 49, the surface pressure applied from the laminated conductive member 12 for a touch panel to the first external connection terminal 26a is reduced, so that even in a case where the conductive member 12 for a touch panel is wound into a roll or a plurality of sheet-like conductive members 12 for a touch panel are laminated to rub against each other, it is difficult for the first external connection terminal 26a of the conductive member 12 for a touch panel to be rubbed to cause a failure.

The outer shape of the non-conductive portion 49 is not particularly limited to be similar to the outer shape of the opening portion 45 as shown in FIG. 13.

Even in the first structure part 40a of the first external connection terminal 26a shown in FIG. 12, in a case where a height of the lead wire is indicated as A, a height of the first structure part is indicated as B, and a height of the second structure part is indicated as C, B<A<C is satisfied. As a result, the occurrence of the spark failure is suppressed.

The height of the first structure part 40a is measured by the method of measuring the height of the first structure part described above.

### Third Example of External Connection Terminal

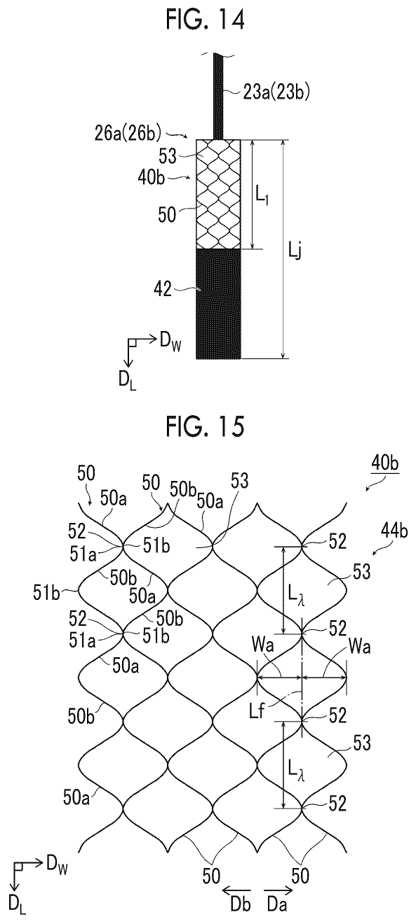

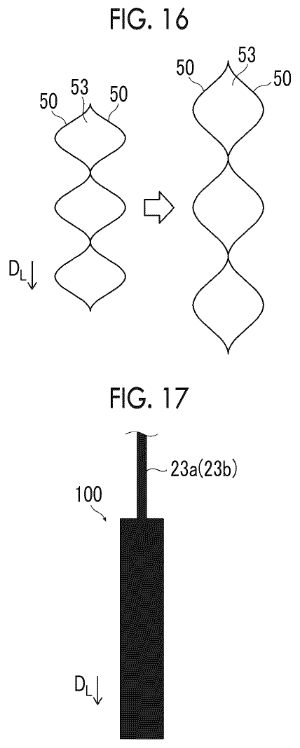

FIG. 14 is a schematic view showing a third example of the external connection terminal in the conductive member for a touch panel according to the embodiment of the present invention. FIG. 15 is a schematic view showing a first structure part of the third example of the external connection terminal in the conductive member for a touch panel according to the embodiment of the present invention. FIG. 16 is a schematic view showing a state in which the first structure part of the third example of the external connection terminal in the conductive member for a touch panel according to the embodiment of the present invention is bent.

In FIG. 14 to FIG. 16, the same reference numerals are assigned to the same configuration components as those in the first external connection terminal 26a shown in FIG. 4 and the first structure part 40 shown in FIG. 5, and the detailed description thereof will not be repeated.

The third example of the first external connection terminal 26a shown in FIG. 14 is different from the first external connection terminal 26a shown in FIG. 4 in that a configuration of a first structure part 40b is different, and the other configurations are the same as the configurations of the first external connection terminal 26a shown in FIG. 4.

In the first structure part 40b of the first external connection terminal 26a shown in FIG. 14, a plurality of wirings 50 in which a first curve 50a which protrudes to a first orientation Da and a second curve 50b which protrudes to a second orientation Db opposite to the first orientation Da are alternately arranged along an extending direction D_{L} are arranged in a width direction D_{w} orthogonal to the extending direction D_{L} of the first external connection terminal 26a, and the wirings 50 are in contact with each other in the width direction D_{w}. In FIG. 15, a top portion 51a of the first curve 50a of the wiring 50 is in contact with a top portion 51b of the second curve 50b of the wiring 50 adjacent in the width direction D_{w}.

A region surrounded by the first curve 50a and the second curve 50b of the wiring 50 adjacent in the width direction D_{w} between two contact points 52 in the extending direction D_{L} is an opening portion 53.

The first structure part 40b of the first external connection terminal 26a has a pattern 44b formed by the curved wiring 50.

In the pattern 44b of the first structure part 40b, a distance Lλ in the extending direction D_{L} between the contact points 52 of the top portion 51a of the first curve 50a of the wiring 50 and the top portion 51b of the second curve 50b of the wiring 50 corresponds to one period of the wiring 50.

In the wiring 50, a distance from a line Lf connecting the contact points 52 to a position farthest in the first orientation Da in the width direction D_{w} corresponds to an amplitude Wa of the wiring 50.

In the wiring 50, a distance from the line Lf connecting the contact points 52 to a position farthest in the second orientation Db in the width direction D_{w} corresponds to an amplitude Wa of the wiring 50.

The first curve 50a and the second curve 50b of the first structure part 40b in the first external connection terminal 26a are, for example, a circular arc, a parabolic curve, or a curve represented by a periodic function. The periodic function is, for example, a trigonometric function. In a case where the first curve 50a and the second curve 50b are curves represented by a trigonometric function, the wiring 50 is, for example, a sine curve.

The first curve 50a and the second curve 50b described above may have the same shape and size, or may have different shapes or sizes.

In a case where a force is applied in the extending direction D_{L} as shown in FIG. 16, it is estimated that, in the first structure part 40b of the first external connection terminal 26a, the opening portion 53 is deformed to follow tensile deformation of the opening portion 53, so that the elongation of the wiring 50 is relaxed, and the wiring 50 is not broken, and thus the wiring 50 is difficult to be broken. Therefore, in a case where the first external connection terminal 26a is bent such that the second structure part 42 is lowered, the wiring 50 is difficult to be disconnected, and thus the cracking of the wiring or the disconnection of the wiring can be suppressed at the time of connecting the first external connection terminal 26a and the flexible substrate 19.

Even in the first structure part 40b of the first external connection terminal 26a shown in FIG. 14, in a case where a height of the lead wire is indicated as A, a height of the first structure part is indicated as B, and a height of the second structure part is indicated as C, B<A<C is satisfied. Therefore, the occurrence of the spark failure is suppressed.

The height of the first structure part 40b is measured by the method of measuring the height of the first structure part described above.

A specific example of the configuration of the first structure part 40b is a configuration in which the top portion 51a of the first curve 50a of the wiring 50 is in contact with the top portion 51b of the second curve 50b of the wiring 50 adjacent in the width direction D_{w}, but the present invention is not particularly limited to this configuration.

For example, a configuration in which wirings adjacent in the width direction are disposed close to each other such that the distance corresponding to the above-described amplitude Wa is equal may be adopted.

In the first structure part 40b, the wiring 50 is configured by alternately arranging the first curve 50a which protrudes to the first orientation Da and the second curve 50b which protrudes to the second orientation Db opposite to the first orientation Da in the width direction D_{w} orthogonal to the extending direction D_{L} of the first external connection terminal 26a as described above, but the present invention is not limited thereto.

For example, in the first structure part 40b, the wiring 50 may be configured by alternately arranging a first triangle which protrudes to the first orientation Da and a second triangle which protrudes to the second orientation Db opposite to the first orientation Da in the width direction D_{w} orthogonal to the extending direction D_{L} of the first external connection terminal 26a as described above. The first triangle and the second triangle described above are not particularly limited, and may be an equilateral triangle, an isosceles triangle, or a right triangle. The first triangle and the second triangle described above may have the same shape and size, or may have different shapes or sizes.

The first triangle and the second triangle may be a first quadrangle and a second quadrangle. Even in this case, the first quadrangle and the second quadrangle described above may have the same shape and size, or may have different shapes or sizes.

In the third example of the first external connection terminal 26a, a configuration in which the above-described non-conductive portion is provided may be adopted as in the second example of the first external connection terminal 26a shown in FIG. 12.

Furthermore, even in the second example of the first external connection terminal 26a shown in FIG. 12 and the third example of the first external connection terminal 26a shown in FIG. 14, the second structure part 42 may have the configuration of the second structure part 42a shown in FIG. 11. That is, the second structure part 42 may be configured to have a mesh-like wiring pattern.

Hereinafter, each unit of the conductive member for a touch panel and the touch panel will be described.

### Substrate

The substrate supports the metal wire, and supports the first detection electrode and the second detection electrode composed of the metal wire. In addition, the substrate supports a first peripheral wiring and a second peripheral wiring, and the first external connection terminal and the second external connection terminal. In addition, in a case where the first detection electrode is disposed on one surface of both surfaces of the substrate and the second detection electrode is disposed on the other surface thereof, the substrate electrically insulates the first detection electrode and the second detection electrode from each other.

For the substrate, for example, a transparent insulating substrate is used. Examples of a material of the substrate include a transparent resin material and a transparent inorganic material. The substrate preferably has a thickness of 20 to 50 μm.

The substrate is preferably a polyethylene terephthalate (PET) film from the viewpoint of cost. In a case where heat resistance is required, a polyethylene naphthalate (PEN) film or a polyimide-based film can be used. In addition, it is possible to use, as the substrate, a film having a thickness in a range of 20 to 50 μm, which is manufactured from a polyethylene resin, a polypropylene-based resin, a methacrylic resin, a cyclic polyolefin-based resin, a polystyrene-based resin, an acrylonitrile-(poly) styrene copolymer (AS resin), an acrylonitrile-butadiene-styrene copolymer (ABS resin), a polyvinyl chloride-based resin, a poly(meth)acrylic resin, a polycarbonate-based resin, a polyester-based resin, a polyamide-based resin, a polyamideimide-based resin, or the like.

The total light transmittance of the substrate is preferably 40% to 100% and more preferably 85% to 100%. The total light transmittance is measured using, for example, “Plastics-Determination of total light transmittance and reflectance” specified in Japanese Industrial Standards (JIS) K 7375:2008.

### Metal Wire

The metal wire 35 constitutes the first detection electrode 30 (see FIG. 2), the first lead wire 23a (see FIG. 2), the second detection electrode 32 (see FIG. 2), and the second lead wire 23b (see FIG. 2) as described above.

Examples of a metal contained in the metal wire include metals such as gold (Au), silver (Ag), copper (Cu), aluminum (Al), nickel (Ni), chromium (Cr), molybdenum (Mo), and tungsten (W), and alloys thereof. Among these, from the viewpoint of excellent conductivity of the metal wire, the metal contained in the metal wire is preferably silver or copper, and more preferably copper or a copper alloy. In addition, the metal wire is not limited to being composed of a metal simple substance and may have a multilayer structure of only metals, which does not include a layer of an oxide or the like. In addition, the metal wire may have a laminated structure, and for example, a laminated structure such as molybdenum/copper/molybdenum and molybdenum/aluminum/molybdenum can be used.

In a case where the metal wire is composed of copper, examples of the material thereof include a copper simple substance (metallic copper) and a mixture (copper alloy) containing copper and a metal other than copper, and the copper simple substance is preferable. Examples of the metal other than copper contained in the copper alloy include silver, gold, aluminum, nickel, molybdenum, chromium, and palladium. In addition, a copper fine wire that is the metal wire may contain a combination of copper or the copper alloy, and a polymer binder such as gelatin and an acrylic-styrene-based latex.

Furthermore, the metal wire may contain, for example, metal oxide particles, metal pastes such as silver paste and copper paste, and metal nanowire particles such as silver nanowires and copper nanowires.

A line width of the metal wire is measured according to the following method.

Using an optical microscope, a surface of the conductive member for a touch panel is observed, and one extending metal wire is selected. In the one selected metal wire, any 10 positions corresponding to the line width of the metal wire are selected. Lengths of the selected positions are measured, and an average value of the lengths of the 10 positions is denoted as the line width of the metal wire.

### Mesh Pattern

The first detection electrode 30 and the second detection electrode 32 are composed of the metal wire 35 as described above. A mesh pattern which is formed by a plurality of the metal wires 35 intersecting with each other as shown in FIG. 3 is composed of, for example, the first detection electrode 30 and the second detection electrode 32.

In the first detection electrode and the second detection electrode, the mesh pattern composed of the metal wires 35 has an opening ratio of preferably 90% or more, and more preferably 95% or more, from the viewpoint of visible light transmittance. The opening ratio is a proportion (%) of a transmissive portion excluding the first detection electrode or the second detection electrode in a region where the first detection electrode or the second detection electrode is provided, and corresponds to a proportion (%) of the opening portion in the entire region where the conductive layer is provided.

The opening ratio of the first detection electrode is obtained by acquiring an optical microscope image of the conductive member for a touch panel using an optical microscope. Next, in the optical microscope image, a region corresponding to the detection unit and the metal wire in the region corresponding to the first detection electrode are specified. An area Sa of the region corresponding to the detection unit and an area Sₘ₁ of a portion corresponding to the metal wire of the first detection electrode are obtained. Next, the opening ratio is obtained using the following expression of the opening ratio (%).

$$Opening ratio ( \% ) = ( ( Sa - {S}_{m 1} ) / Sa ) \times 100$$

The opening ratio of the second detection electrode is obtained by acquiring an optical microscope image of the conductive member for a touch panel using an optical microscope. Next, in the optical microscope image, a region corresponding to the detection unit and the metal wire in the region corresponding to the second detection electrode are specified. An area Sa of the region corresponding to the detection unit and an area Sₘ₂ of a portion corresponding to the metal wire of the second detection electrode are obtained. Next, the opening ratio is obtained using the following expression of the opening ratio (%).

$$Opening ratio ( \% ) = ( ( Sa - {S}_{m 2} ) / Sa ) \times 100$$

The first lead wire 23a and the second lead wire 23b may have a mesh pattern in which a plurality of metal wires 35 intersect each other.

In a case where the first detection electrode 30 and the second detection electrode 32, and the first lead wire 23a and the second lead wire 23b are configured to have a mesh pattern, a pattern of the mesh pattern is not particularly limited and is preferably a geometric shape which is obtained by combining a triangle such as an equilateral triangle, an isosceles triangle, and a right triangle, a quadrangle such as a square, a rectangle, a rhombus, a parallelogram, and a trapezoid, an (regular) n-sided polygon such as a (regular) hexagon and a (regular) octagon, a circle, an ellipse, a star shape, and the like.

The mesh of the mesh pattern is intended to be a shape including a plurality of opening portions 36 composed of the intersecting metal wires 35. The opening portion 36 is an opening region surrounded by the metal wires 35. In FIG. 3, the opening portion 36 has a rhombic shape, but may have another shape. For example, the shape may be a polygonal shape (for example, a triangle, a quadrangle, a hexagon, and a random polygonal shape). In addition, the shape of one side may be a curved shape or an arc shape, in addition to a linear shape. In a case of the arc shape, for example, two opposing sides may have an outwardly convex arc shape, and other two opposing sides may have an inwardly convex arc shape. In addition, the shape of each side may be a wavy shape in which the outwardly convex arc and the inwardly convex arc are connected. Needless to say, the shape of each side may be a sine curve. The mesh pattern is not particularly limited, and may be a random pattern or a regular pattern or may be a regular mesh pattern in which a plurality of congruent shapes are repeatedly disposed.

The mesh pattern is preferably a regular mesh pattern having the same rhombic lattice. A length of one side of the rhombus, that is, a length W of one side of the opening portion 36 (see FIG. 3) is preferably 50 to 1,500 μm, more preferably 150 to 800 μm, and still more preferably 200 to 600 μm, from the viewpoint of visibility. In a case where the length W of one side of the opening portion 36 is within the above-described range, favorable transparency can be also further maintained, and a display can be visible without a sense of discomfort, in a case where the conductive member 12 for a touch panel (see FIG. 1) is attached onto the display surface 14a (see FIG. 1) of the image display unit 14 (see FIG. 1).

The mesh pattern of the metal wire can be observed and measured using an optical microscope.

### External Connection Terminal

The external connection terminal is a terminal which is connected to the flexible substrate through the anisotropic conductive film as described above. The configuration thereof is as described above. The external connection terminal is formed of, for example, the same material as the metal wire described above.

### Manufacturing Method of Conductive Member for Touch Panel

A manufacturing method of the conductive member for a touch panel is not particularly limited as long as it is a method capable of forming the first detection electrode 30 (see FIG. 2), the first lead wire 23a (see FIG. 2), the second detection electrode 32 (see FIG. 2), the second lead wire 23b (see FIG. 2), the first external connection terminal 26a (see FIG. 2), and the second external connection terminal 26b (see FIG. 2), which are constituent members constituting the conductive member for a touch panel; and for example, a sputtering method, a plating method, a silver salt method, a printing method, and the like can be appropriately used.

A method of forming the above-described constituent member of the conductive member for a touch panel by the sputtering method will be described. First, a copper foil layer is formed by sputtering, and a copper wiring is formed from the copper foil layer by a photolithography method. The copper foil layer can also be formed by so-called vapor deposition instead of the sputtering. As the copper foil layer, an electrolytic copper foil can be used in addition to a sputtered copper foil and a vapor deposited copper foil. More specifically, a step of forming copper wires described in JP2014-029614A can be used.

A method of forming the above-described constituent member of the conductive member for a touch panel by the plating method will be described. For example, by subjecting an electroless plating underlayer to electroless plating, a metal plating film is formed on the underlayer. The metal plating film can be used as a detection electrode. In this case, the above-described constituent member of the conductive member for a touch panel is formed by forming a catalyst ink containing at least metal fine particles in a patterned form on the substrate, and then immersing the substrate in an electroless plating bath to form a metal plating film. More specifically, a method of manufacturing a metal-coated substrate described in JP2014-159620A can be used.

In addition, the constituent member of the conductive member for a touch panel is formed by forming a resin composition having a functional group capable of interacting with at least a metal catalyst precursor in a patterned form on the substrate, applying a catalyst or a catalyst precursor, and then immersing the substrate in an electroless plating bath to form a metal plating film. More specifically, a method of manufacturing a metal-coated substrate described in JP2012-144761A can be used.

A method of forming the above-described constituent member of the conductive member for a touch panel by the silver salt method will be described. First, an exposure treatment is performed on a silver salt emulsion layer containing a silver halide using an exposure pattern corresponding to a pattern of the detection electrode, and then a development treatment is performed to form the constituent member of the conductive member for a touch panel. More specifically, a method of manufacturing a fine metal wire described in JP2012-006377A, JP2014-112512A, JP2014-209332A, JP2015-022397A, JP2016-192200A, or WO2016/157585A can be used.

A method of forming the above-described constituent member of the conductive member for a touch panel by the printing method will be described. First, a conductive paste containing a conductive powder is applied onto a substrate in the same pattern as the detection electrode, and then a heating treatment is performed to form the constituent member of the conductive member for a touch panel. The pattern formation using the conductive paste is performed, for example, by an inkjet method or a screen printing method. As the conductive paste, more specifically, a conductive paste described in JP2011-028985A can be used.

### Manufacturing Method of External Connection Terminal

As a manufacturing method of the external connection terminal, the sputtering method and the plating method described above can be used, and the silver salt method can also be used. Hereinafter, a method of manufacturing the external connection terminal by the silver salt method will be described.

First, a glass mask on which an exposure pattern forming the external connection terminal is formed is disposed on a silver salt emulsion layer containing a silver halide. Furthermore, in order to obtain a desired pattern thickness at each of the lead wire and the external connection terminal, a filter for reducing light is installed at various locations on the glass mask. For example, an exposure treatment is performed on the substrate using parallel light with a high-pressure mercury lamp as a light source in a state in which the filter for reducing light is installed at various locations on the glass mask. Thereafter, the external connection terminal can be formed by performing a development treatment.

By adjusting a transmittance of the filter for reducing light, the height A of the lead wire, the height B of the first structure part, and the height C of the second structure part can be adjusted, and the external connection terminal satisfying B<A<C can be formed.

For example, a film-type neutral density (ND) filter is used as the filter for reducing light.

By installing the film-type ND filter on the surface of the glass mask on the exposure light source side, the exposure amount of the halide silver sensitive material at the portion where the film-type ND filter is installed can be reduced. In the halide silver sensitive material, a thick developed silver wiring can be obtained in a case where the exposure amount is large, and a thin developed silver wiring can be obtained in a case where the exposure amount is small. By adjusting the exposure amount and adjusting the amount of light reduction by the ND filter, a desired thickness of the developed silver wiring can be obtained at each portion. The above-described thickness is synonymous with a high height, and the above-described thin thickness is synonymous with a low height.

In addition to the method of installing the filter for reducing light at various locations on the glass mask, the external connection terminal can be formed by, for example, performing an exposure treatment on the substrate using parallel light with a high-pressure mercury lamp as a light source in a state in which the glass mask on which the exposure pattern forming the external connection terminal is formed and the exposure amount is locally different is disposed on the silver salt emulsion layer containing a silver halide, and then performing a development treatment. More specifically, a method of manufacturing a fine metal wire described in JP2012-006377A, JP2014-112512A, JP2014-209332A, JP2015-22397A, JP2016-192200A, or WO2016/157585A can be used.

Next, a method of manufacturing the glass mask where the exposure amount varies locally will be described. First, in a substrate for a glass mask where a chromium film is uniformly formed on one surface of blue plate glass, the chromium film is etched by photolithography to produce a first pattern mask where the chromium film is patterned. Next, a photoresist film is formed on the surface of the first pattern mask where the chromium film is disposed, and the photoresist film is patterned by photolithography to produce a second pattern mask. The patterned photoresist film has an opening portion at a predetermined position where the chromium film is etched. Next, a chromium thin film having a predetermined film thickness is formed on the second pattern mask by sputtering using a chromium target. Next, by removing the photoresist film, a glass mask including a portion where the initial chromium film is formed on the glass, a portion where the glass is exposed, and a portion where the chromium thin film is formed on the glass by sputtering is obtained. The exposure amount in the portion where the chromium thin film is formed on the glass by sputtering is less than that in the portion where the glass is exposed. By adjusting the film thickness of the chromium thin film by sputtering, the exposure amount in the portion can be adjusted. As a result, the height A of the lead wire, the height B of the first structure part, and the height C of the second structure part can be adjusted, and the external connection terminal satisfying B<A<C can be formed.

The present invention is basically configured as described above. The conductive member for a touch panel, the touch panel, and the image display device according to the embodiments of the present invention have been described in detail above, but the present invention is not limited to the above-described embodiments, and various improvements and changes can be made without departing from the spirit of the present invention.

### EXAMPLES

Hereinafter, the characteristics of the present invention will be described in detail by Examples. The materials, reagents, amounts and proportions of substances, operations, and the like described in the following examples can be appropriately modified as long as the gist of the present invention is maintained. Therefore, the scope of the present invention is not limited to Examples below.

In the present examples, conductive members for a touch panel at levels 1 to 18 were produced, and spark resistance and bondability with a flexible substrate were evaluated. Among the levels 1 to 18, the levels 1 to 4 correspond to Comparative Examples, and the levels 5 to 13 correspond to Examples.

Hereinafter, the conductive members for a touch panel at levels 1 to 18 will be described.

### Level 1

### Preparation of Silver Halide Emulsion

An amount of each of 90% of the following solution 2 and the following solution 3 was added to the following solution 1 maintained at 38° C. and a potential hydrogen (pH) of 4.5 over 20 minutes while stirring the solution 1, thereby forming nuclear particles of 0.16 μm. Next, the following solution 4 and the following solution 5 were added to the obtained solution over 8 minutes, and the remaining 10% amount of the following solution 2 and the following solution 3 was further added over 2 minutes, so that the nuclear particles grew to a size of 0.21 μm. Furthermore, 0.15 g of potassium iodide was added to the obtained solution, and the mixture was aged for 5 minutes to complete particle formation.

Solution 1:

| | | |
|---|---|---|
| Water | 750 | ml |
| Gelatin | 8.6 | g |
| Potassium bromide | 3 | g |
| 1,3-Dimethylimidazolidine-2-thione | 20 | mg |
| Sodium benzenethiosulfonate | 10 | mg |
| Citric acid | 0.7 | g |

Solution 2:

| | | |
|---|---|---|
| Water | 300 | ml |
| Silver nitrate | 150 | g |

Solution 3:

| | | |
|---|---|---|
| Water | 300 | ml |
| Sodium chloride | 38 | g |
| Potassium bromide | 32 | g |
| Potassium hexachloroiridate (III) (20% aqueous solution | 5 | ml |
| of 0.005% KCl) | | |
| Ammounium hexachlororhodate (20% aqueous solution of | 7 | ml |
| 0.001% NaCl) | | |

Solution 4:

| | | |
|---|---|---|
| Water | 100 | ml |
| Silver nitrate | 50 | g |

Solution 5:

| | | |
|---|---|---|
| Water | 100 | ml |
| Sodium chloride | 13 | g |
| Potassium bromide | 11 | g |
| Yellow prussiate of potash | 5 | mg |

Thereafter, the mixture was washed with water by a flocculation method according to a conventional method. Specifically, the temperature of the obtained solution described above was decreased to 35° C. and the pH thereof was decreased (the pH thereof was in a range of 3.6±0.2) using sulfuric acid until silver halide was precipitated. Next, approximately 3 L of the supernatant solution was removed from the obtained solution (first water washing). Next, 3 L of distilled water was added to the solution from which the supernatant solution was removed, and then sulfuric acid was added thereto until silver halide was precipitated. 3 L of the supernatant solution was removed again from the obtained solution (second water washing). The same operation as the second water washing was repeated once more (third water washing), whereby water washing and desalting steps were completed. The emulsion after the water washing and desalting was adjusted to have a pH of 6.4 and a pAg of 7.5, 2.5 g of gelatin, 10 mg of sodium benzenethiosulfonate, 3 mg of sodium benzenethiosulfinate, 15 mg of sodium thiosulfate, and 10 mg of chloroauric acid were added thereto, and chemosensitization was carried out at 55° C. so that the optimum sensitivity was obtained. Thereafter, 100 mg of 1,3,3a, 7-tetraazaindene as a stabilizer and 100 mg of PROXEL (trade name, manufactured by ICI Co., Ltd.) as a preservative were further added to the obtained emulsion. The finally obtained emulsion was a silver iodochlorobromide cubic particle emulsion having an average particle diameter (sphere equivalent diameter) of 0.22 μm and a coefficient of variation of 9%, in which a content of silver iodide was 0.08 mol % and a ratio of silver chlorobromide was 70 mol % of silver chloride/30 mol % of silver bromide.

### Preparation of Composition for Forming Photosensitive Layer

1,3,3a,7-tetraazaindene (1.2×10⁻⁴ mol/mol Ag), hydroquinone (1.2×10⁻² mol/mol Ag), citric acid (3.0×10⁻⁴ mol/mol Ag), 2,4-dichloro-6-hydroxy-1,3,5-triazine sodium salt (0.90 g/mol Ag), and a trace amount of a hardening agent were added to the above-described emulsion to obtain a composition. Next, a pH of the composition was adjusted to 5.6 using citric acid.

A polymer latex containing a polymer represented by Formula (P-1) shown below and a dispersant formed of dialkylphenyl PEO sulfuric acid ester (mass ratio dispersant/polymer was 2.0/100=0.02) was added to the above-described composition such that polymer/gelatin (mass ratio) of the polymer to the gelatin in the composition was 0.5/1.

Furthermore, EPOXY RESIN DY 022 (trade name, manufactured by Nagase ChemteX Corporation) as a crosslinking agent was added thereto. An addition amount of the crosslinking agent was adjusted such that the amount of the crosslinking agent in the silver halide-containing photosensitive layer described below was 0.09 g/m².

In this way, a composition for forming a photosensitive layer was prepared.

The polymer represented by Formula (P-1) shown below was synthesized with reference to JP3305459B and JP3754745B.

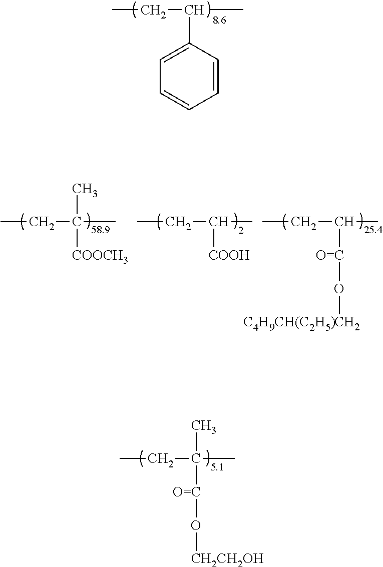

### Photosensitive Layer Forming Step

A corona discharge treatment was carried out on an insulating substrate, a gelatin layer having a thickness of 0.1 μm as an undercoat layer was provided on one surface of the substrate, and an antihalation layer containing a dye having an optical density of approximately 1.0 and decolorized by an alkali developer was provided on the undercoat layer. The above-described composition for forming a photosensitive layer was applied onto the above-described antihalation layer, and a gelatin layer having a thickness of 0.15 μm was further provided to obtain a substrate on which the photosensitive layers were formed on both surfaces. In the formed photosensitive layer, the amount of silver was 6.0 g/m² and the amount of gelatin was 1.0 g/m²

### Exposure Development Step

A plurality of first detection electrodes 30 and a glass mask corresponding to a pattern of a plurality of lead wires and a plurality of external connection terminals as shown in FIG. 2 were disposed on one surface of the substrate on which the photosensitive layer was formed. In this state, the substrate was exposed using parallel light with a high-pressure mercury lamp as a light source. In order to obtain a desired pattern thickness at each of the lead wire and the external connection terminal, a filter for reducing light was installed at various locations on the glass mask.

A film-type ND filter was used as the filter for reducing light.

After the exposure, the surfaces of the film were developed using the following developer, and were developed using a fixing solution (trade name: N3X-R for CN16X, manufactured by Fujifilm Corporation). Furthermore, the film was rinsed with pure water and dried to obtain a substrate on which a conductive member consisting of an Ag wire and a gelatin layer were formed on both surfaces. The gelatin layer was formed between the Ag wires.

### Formulation of Developer

The following compounds were contained in 1 liter (L) of the developer.

| | |
|---|---|
| Hydroquinone | 0.037 mol/L |
| N-Methylaminophenol | 0.016 mol/L |
| Sodium metaborate | 0.140 mol/L |
| Sodium hydroxide | 0.360 mol/L |
| Sodium bromide | 0.031 mol/L |
| Potassium metabisulfite | 0.187 mol/L |

### Gelatin Decomposition Treatment

The substrate on which the conductive member consisting of the Ag wire and the gelatin layer were formed on both surfaces was dipped in an aqueous solution (concentration of protease: 0.5% by mass, liquid temperature: 40° C.) of proteolytic enzyme (BIOPRASE AL-15FG manufactured by Nagase ChemteX Corporation) for 120 seconds. The substrate was taken out from the aqueous solution, dipped in warm water (liquid temperature: 50° C.) for 120 seconds, and cleaned.

### Resistance Reducing Treatment

The substrate after the gelatin decomposition treatment was calendared at a pressure of 30 kN using a calendering device including a metal roller. After the calendering treatment, the substrate was heated by being caused to pass through a superheated steam bath at a temperature of 150° C. for 120 seconds.

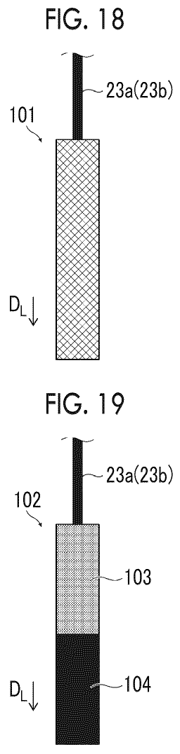

An external connection terminal 100 having a shape shown in FIG. 17 was formed on one surface of the substrate obtained as described above. The external connection terminal 100 had a width of 150 μm and a length of 2.0 mm, and had a solid film configuration. The external connection terminal 100 had a configuration in which the first structure part was not provided and only the second structure part was provided. Therefore, “−” is indicated in the column of the first structure part, the column of B<A<C, the column of B÷C, and the column of the pattern of the first structure part, and the opening ratio of the first structure part in Table 1 below. It should be noted that the opening ratio of the solid film was set to 0%.

The height of the lead wire at the level 1 was 1.5 μm, and the height of the external connection terminal portion was 2.0 μm (level 1). The height of the external connection terminal portion corresponded to the height of the second structure part.

Each size of the lead wire and the external connection terminal was measured using an optical microscope (digital microscope VHX-7000 manufactured by KEYENCE CORPORATION).

The height of the lead wire and the height of the external connection terminal portion were values calculated as average values of any 10 points measured from cross-sectional images acquired by a scanning electron microscope (SEM).

In FIG. 17, the same reference numerals are assigned to the same configuration components as those in the first external connection terminal 26a shown in FIG. 4, and the detailed description thereof will not be repeated.

### Level 2

The level 2 was different from the level 1 in that the configuration of the external connection terminal was a configuration of an external connection terminal 101 shown in FIG. 18.

The external connection terminal 101 at the level 2 shown in FIG. 18 was composed of wirings arranged in a mesh-like pattern. The wiring pattern was the pattern 44 shown in FIG. 5, and the line width was 1.7 μm, the angle α (see FIG. 5) was 45°, and the length Wp (see FIG. 5) of one side of the opening portion 45 (see FIG. 5) was 20 μm. An opening ratio of the wiring pattern was 84%.

In the level 2, the external connection terminal was produced in the same manner as in the level 1 using the glass mask corresponding to the configuration of the external connection terminal and the filter for reducing light installed at various locations on the glass mask.

In the external connection terminal at the level 2, the height of the lead wire was 1.5 μm, and the height of the external connection terminal portion was 1.0 μm. The height of the external connection terminal portion corresponded to the height of the first structure part.

In FIG. 18, the same reference numerals are assigned to the same configuration components as those in the first external connection terminal 26a shown in FIG. 4, and the detailed description thereof will not be repeated.

The external connection terminal 101 at the level 2 had a configuration in which only the first structure part was provided and the second structure part was not provided. Therefore, “−” is indicated in the column of the second structure part, the column of B<A<C, the column of A÷C, the column of B÷C, and the column of the pattern of the second structure part, and the opening ratio of the first structure part in Table 1 below.

### Level 3

The level 3 was different from the level 1 in that the configuration of the external connection terminal was a configuration of an external connection terminal 102 shown in FIG. 19.

The external connection terminal 102 at the level 3 shown in FIG. 19 had a first structure part 103 and a second structure part 104, having a solid film configuration, and heights of the first structure part 103 and the second structure part 104 were different. The height of the first structure part 103 was 1.0 μm, and the height of the second structure part 104 was 2.0 μm. The first structure part 103 and the second structure part 104 had the same length in the extending direction D_{L}.

In the level 3, the external connection terminal was produced in the same manner as in the level 1 using the glass mask corresponding to the configuration of the external connection terminal and the filter for reducing light installed at various locations on the glass mask.

In the external connection terminal at the level 3, the height of the lead wire was 1.5 μm, the height of the first structure part of the external connection terminal portion was 1.0 μm, and the height of the second structure part was 2.0 μm.

The height of the lead wire, the height of the first structure part of the external connection terminal portion, and the height of the second structure part were values calculated as average values of any 10 points measured from cross-sectional images acquired by a scanning electron microscope (SEM).

In FIG. 19, the same reference numerals are assigned to the same configuration components as those in the first external connection terminal 26a shown in FIG. 4, and the detailed description thereof will not be repeated.

Since the first structure part 103 of the external connection terminal 102 at the level 3 was not a mesh-like wiring pattern, “−” is indicated in the column of B<A<C in Table 1 below. In the level 3, since the first structure part 103 and the second structure part 104 were solid films, the opening ratios thereof were 0%. In the following, unless otherwise specified, the opening ratio of the solid film is 0%.

In the following, unless otherwise specified, the height of the lead wire, the height of the first structure part of the external connection terminal portion, and the height of the second structure part were values calculated as average values of any 10 points measured from cross-sectional images acquired by a scanning electron microscope (SEM).

### Level 4

The level 4 was different from the level 1 in that the configuration of the external connection terminal was the configuration of the first external connection terminal 26a shown in FIG. 4.

The external connection terminal at the level 4 had the first structure part 40 and the second structure part 42, and heights of the first structure part 40 and the second structure part 42 were the same. The heights of the first structure part 40 and the second structure part 42 were 2.0 μm. The first structure part 40 and the second structure part 42 had the same length in the extending direction D_{L}.

The first structure part 40 at the level 4 had a mesh-like wiring pattern. The pattern was the pattern shown in FIG. 5, and the line width was 1.7 μm, the angle α (see FIG. 5) was 45°, and the length Wp (see FIG. 5) of one side of the opening portion 45 (see FIG. 5) was 20 μm. An opening ratio of the pattern was 84%. The second structure part 42 had a solid film configuration.

In the level 4, the external connection terminal was produced in the same manner as in the level 1 using the glass mask corresponding to the configuration of the external connection terminal and the filter for reducing light installed at various locations on the glass mask.

In the external connection terminal at the level 4, the height of the lead wire was 2.0 μm, the height of the first structure part of the external connection terminal portion was 2.0 μm, the height of the second structure part was 2.0 μm, and the opening ratio of the pattern was 84%.

### Level 5

The level 5 was different from the level 1 in that the configuration of the external connection terminal was the configuration of the first external connection terminal 26a shown in FIG. 4.

The external connection terminal at the level 5 had the first structure part 40 and the second structure part 42, and heights of the first structure part 40 and the second structure part 42 were different. The height of the first structure part 40 was 1.0 μm, and the height of the second structure part 42 was 2.0 μm. The first structure part 40 and the second structure part 42 had the same length in the extending direction D_{L}.

The first structure part 40 at the level 5 had a mesh-like wiring pattern. The pattern was the pattern shown in FIG. 5, and the line width was 1.7 μm, the angle α (see FIG. 5) was 45°, and the length Wp (see FIG. 5) of one side of the opening portion 45 (see FIG. 5) was 20 μm. An opening ratio of the pattern was 84%. The second structure part 42 had a solid film configuration.

In the level 5, the external connection terminal was produced in the same manner as in the level 1 using the glass mask corresponding to the configuration of the external connection terminal and the filter for reducing light installed at various locations on the glass mask.

In the external connection terminal at the level 5, the height of the lead wire was 1.5 μm, the height of the first structure part of the external connection terminal portion was 1.0 μm, and the height of the second structure part was 2.0 μm.

### Level 6

The level 6 was different from the level 5 in that, in the external connection terminal, a height of the lead wire was 1.05 μm, a height of the first structure part of the external connection terminal portion was 1.0 μm, and a height of the second structure part was 2.0 μm; and the other configurations were the same as those of the level 5.

In the level 6, the external connection terminal was produced in the same manner as in the level 5 using the glass mask corresponding to the configuration of the external connection terminal and the filter for reducing light installed at various locations on the glass mask. As a result, the height of the lead wire was 1.05 μm, the height of the first structure part of the external connection terminal portion was 1.0 μm, and the height of the second structure part was 2.0 μm.

### Level 7

The level 7 was different from the level 5 in that, in the external connection terminal, a height of the lead wire was 1.35 μm, a height of the first structure part of the external connection terminal portion was 1.0 μm, and a height of the second structure part was 2.0 μm; and the other configurations were the same as those of the level 5.

In the level 7, the external connection terminal was produced in the same manner as in the level 5 using the glass mask corresponding to the configuration of the external connection terminal and the filter for reducing light installed at various locations on the glass mask. As a result, the height of the lead wire was 1.35 μm, the height of the first structure part of the external connection terminal portion was 1.0 μm, and the height of the second structure part was 2.0 μm.

### Level 8

The level 8 was different from the level 5 in that, in the external connection terminal, a height of the lead wire was 1.95 μm, a height of the first structure part of the external connection terminal portion was 1.0 μm, and a height of the second structure part was 2.0 μm; and the other configurations were the same as those of the level 5.

In the level 8, the external connection terminal was produced in the same manner as in the level 5 using the glass mask corresponding to the configuration of the external connection terminal and the filter for reducing light installed at various locations on the glass mask. As a result, the height of the lead wire was 1.95 μm, the height of the first structure part of the external connection terminal portion was 1.0 μm, and the height of the second structure part was 2.0 μm.

### Level 9

The level 9 was different from the level 5 in that, in the external connection terminal, a height of the lead wire was 1.5 μm, a height of the first structure part of the external connection terminal portion was 1.45 μm, and a height of the second structure part was 2.0 μm; and the other configurations were the same as those of the level 5.

In the level 9, the external connection terminal was produced in the same manner as in the level 5 using the glass mask corresponding to the configuration of the external connection terminal and the filter for reducing light installed at various locations on the glass mask. As a result, the height of the lead wire was 1.5 μm, the height of the first structure part of the external connection terminal portion was 1.45 μm, and the height of the second structure part was 2.0 μm.

### Level 10

The level 10 was different from the level 5 in that, in the external connection terminal, a height of the lead wire was 1.5 μm, a height of the first structure part of the external connection terminal portion was 0.45 μm, and a height of the second structure part was 2.0 μm; and the other configurations were the same as those of the level 5.

In the level 10, the external connection terminal was produced in the same manner as in the level 5 using the glass mask corresponding to the configuration of the external connection terminal and the filter for reducing light installed at various locations on the glass mask. As a result, the height of the lead wire was 1.5 μm, the height of the first structure part of the external connection terminal portion was 0.45 μm, and the height of the second structure part was 2.0 μm.

### Level 11

The level 11 was different from the level 5 in that, in the external connection terminal, a height of the lead wire was 1.35 μm, a height of the first structure part of the external connection terminal portion was 0.45 μm, and a height of the second structure part was 2.0 μm; and the other configurations were the same as those of the level 5.

In the level 11, the external connection terminal was produced in the same manner as in the level 5 using the glass mask corresponding to the configuration of the external connection terminal and the filter for reducing light installed at various locations on the glass mask. As a result, the height of the lead wire was 1.35 μm, the height of the first structure part of the external connection terminal portion was 0.45 μm, and the height of the second structure part was 2.0 μm.

### Level 12

The level 12 was different from the level 5 in that, in the external connection terminal, a height of the lead wire was 1.95 μm, a height of the first structure part of the external connection terminal portion was 0.45 μm, and a height of the second structure part was 2.0 μm; and the other configurations were the same as those of the level 5.

In the level 12, the external connection terminal was produced in the same manner as in the level 5 using the glass mask corresponding to the configuration of the external connection terminal and the filter for reducing light installed at various locations on the glass mask. As a result, the height of the lead wire was 1.95 μm, the height of the first structure part of the external connection terminal portion was 0.45 μm, and the height of the second structure part was 2.0 μm.

### Level 13

The level 13 was different from the level 5 in that, in the external connection terminal, a height of the lead wire was 1.95 μm, a height of the first structure part of the external connection terminal portion was 1.45 μm, and a height of the second structure part was 2.0 μm; and the other configurations were the same as those of the level 5.

In the level 13, the external connection terminal was produced in the same manner as in the level 5 using the glass mask corresponding to the configuration of the external connection terminal and the filter for reducing light installed at various locations on the glass mask. As a result, the height of the lead wire was 1.95 μm, the height of the first structure part of the external connection terminal portion was 1.45 μm, and the height of the second structure part was 2.0 μm.

### Level 14

The level 14 was different from the level 5 in that, in the external connection terminal, the first structure part 40 and the second structure part 42 had different lengths in the extending direction D_{L}; and the other configurations were the same as those of the level 5. A proportion of the length L₁ of the first structure part 40 in the extending direction D_{L} was 24%, and a proportion of the length L₁ of the second structure part 42 in the extending direction D_{L} was 76%.

In the level 14, the external connection terminal was produced in the same manner as in the level 5 using the glass mask corresponding to the configuration of the external connection terminal and the filter for reducing light installed at various locations on the glass mask. As a result, the height of the lead wire was 1.5 μm, the height of the first structure part of the external connection terminal portion was 1.0 μm, and the height of the second structure part was 2.0 μm. Furthermore, the proportion of the length L₁ of the first structure part 40 in the extending direction D_{L} was 24%, and the proportion of the length L₁ of the second structure part 42 in the extending direction D_{L} was 76%.

### Level 15

The level 15 was different from the level 5 in that, in the external connection terminal, the first structure part 40 and the second structure part 42 had different lengths in the extending direction D_{L}; and the other configurations were the same as those of the level 5. A proportion of the length L₁ of the first structure part 40 in the extending direction D_{L} was 75%, and a proportion of the length L₁ of the second structure part 42 in the extending direction D_{L} was 25%.

In the level 15, the external connection terminal was produced in the same manner as in the level 5 using the glass mask corresponding to the configuration of the external connection terminal and the filter for reducing light installed at various locations on the glass mask. As a result, the height of the lead wire was 1.5 μm, the height of the first structure part of the external connection terminal portion was 1.0 μm, and the height of the second structure part was 2.0 μm. Furthermore, the proportion of the length L₁ of the first structure part 40 in the extending direction D_{L} was 75%, and the proportion of the length L₁ of the second structure part 42 in the extending direction D_{L} was 25%.

### Level 16

The level 16 was different from the level 5 in that, in the external connection terminal, a height of the lead wire was 1.5 μm, a height of the first structure part of the external connection terminal portion was 1.0 μm, a height of the second structure part was 2.0 μm, and the mesh-like wiring pattern was the pattern 44a formed by curves shown in FIGS. 14 and 15; and the other configurations were the same as those of the level 5.

In the pattern 44a of the first structure part 40 at the level 16, a line width of the wiring was 1.7 μm, a distance Lλ corresponding to one period of the wiring was 28.3 μm, and an amplitude Wa of the wiring was 14.1 μm. An opening ratio of the pattern was 77%.

In the level 16, the external connection terminal was produced in the same manner as in the level 5 using the glass mask corresponding to the configuration of the external connection terminal and the filter for reducing light installed at various locations on the glass mask. As a result, the height of the lead wire was 1.5 μm, the height of the first structure part of the external connection terminal portion was 1.0 μm, the height of the second structure part was 2.0 μm, and the opening ratio of the pattern was 77%.

### Level 17

The level 17 was different from the level 5 in that, in the external connection terminal, both the first structure part and the second structure part of the external connection terminal portion were a mesh-like wiring pattern; and the other configurations were the same as those of the level 5. The external connection terminal at the level 17 had the configuration shown in FIG. 11. The pattern of the first structure part at the level 17 was the same as that at the level 5.

In the pattern of the second structure part at the level 17, the line width was 5 μm, the angle α (see FIG. 5) was 45°, and the length Wp (see FIG. 5) of one side of the opening portion 45 (see FIG. 5) was 20 μm. An opening ratio of the pattern was 56%.

In the level 17, the external connection terminal was produced in the same manner as in the level 5 using the glass mask corresponding to the configuration of the external connection terminal and the filter for reducing light installed at various locations on the glass mask. As a result, the height of the lead wire was 1.5 μm, the height of the first structure part of the external connection terminal portion was 1.0 μm, the height of the second structure part was 2.0 μm, the opening ratio of the pattern of the first structure part was 84%, and the opening ratio of the pattern of the second structure part was 56%.

### Level 18

The level 18 was different from the level 5 in that, in the external connection terminal, the configuration of the first structure part of the external connection terminal portion was different; and the other configurations were the same as those of the level 5. The external connection terminal at the level 18 had the configuration shown in FIG. 12. The pattern of the second structure part at the level 18 was the same as that at the level 5.

In the pattern of the first structure part at the level 18, the line width was 5 μm, the angle α (see FIG. 13) was 45°, and the length Wp (see FIG. 13) of one side of the opening portion 45 (see FIG. 13) was 20 μm. The length Lp (see FIG. 13) of one side of the non-conductive portion 49 was 8.3 μm.

An opening ratio of the wiring pattern was 67%.

In the level 18, the external connection terminal was produced in the same manner as in the level 5 using the glass mask corresponding to the configuration of the external connection terminal and the filter for reducing light installed at various locations on the glass mask. As a result, the height of the lead wire was 1.5 μm, the height of the first structure part of the external connection terminal portion was 1.0 μm, and the height of the second structure part was 2.0 μm. In addition, the opening ratio of the pattern of the first structure part was 67%.

In the levels 1 to 18, in a case where the height A of the lead wire, the height B of the first structure part, and the height C of the second structure part satisfied B<A<C, “OK” is indicated in the column of B<A<C in Tables 1 and 2 below.

In the levels 1 to 18, in a case where the height A of the lead wire, the height B of the first structure part, and the height C of the second structure part did not satisfy B<A<C, “NG” is indicated in the column of B<A<C in Tables 1 and 2 below.

### Spark Resistance

For each of the levels 1 to 18, 1,000 sheet-like conductive members for a touch panel, in which it was confirmed in advance that there was no conduction failure in all electrodes, were prepared, and the 1,000 conductive members were laminated. One day elapsed in a state in which the 1,000 conductive members were laminated. Thereafter, one conductive member for a touch panel was taken out, and a resistance value between the second structure part of each external connection terminal and the end part of the detection electrode electrically connected to the external connection terminal was measured.

Since the level 2 had the configuration in which the second structure part was not provided, a resistance value between the external connection terminal and the end part of the detection electrode was measured.

In a case where there was one or more portions where the above-described resistance value could not be measured (overload), the conductive member for a touch panel was determined to be a touch sensor with conduction failure.

A proportion of the number of touch sensors with conduction failure to all 1,000 conductive members for a touch panel was calculated as a defective product occurrence rate (spark failure NG rate).

For each of the levels 1 to 18, the test of measuring the resistance value after laminating 1,000 conductive members for a touch panel for one day described above was performed 10 times using separate samples, and an average value of the defective product occurrence rates in 10 times was calculated. The average value of the defective product occurrence rates in 10 times was set as the result of the defective product occurrence rate of each of the levels 1 to 18. That is, 1,000 sheet-like conductive members for a touch panel were prepared in 10 sets, the test of measuring the resistance value described above was performed for each set, the defective product occurrence rate in 10 times was calculated, and the average value of the defective product occurrence rates in 10 times was set as the result of the defective product occurrence rate of each of the levels 1 to 18.

It was determined that sufficient manufacturing efficiency was obtained in a case where the defective product occurrence rate was 0.5% or less.

It was determined that sufficient manufacturing efficiency was not obtained in a case where the defective product occurrence rate was more than 0.5%.

Bondability with Flexible Substrate

A sheet-like conductive member for a touch panel, in which it was confirmed in advance that there was no conduction failure in all electrodes, was prepared. A release paper of an optical clear adhesive (8146-3 (OCA manufactured by 3M)) was peeled off from the surface opposite to the film surface on which the external connection terminal was disposed, and the adhesive surface was bonded. In this case, the release paper on the heavy peeling side was not peeled off. The optical clear adhesive was bonded such that the end part of the optical clear adhesive was disposed at a position 200 μm from a connection boundary position between the lead wire and the external connection terminal toward the external connection terminal side. A flexible substrate (FPC) was pressure-bonded through an anisotropic conductive film (ACF) at a position 300 μm away from the end part of the optical clear adhesive.

As the anisotropic conductive film, CP920CM-25AC (model number, 1.5 mm width) manufactured by Dexerials Corporation was used.

The pressure bonding was carried out under conditions of temperature 100° C. and time 3 seconds for preliminary pressure bonding, and under conditions of temperature 130° C., pressure 2.5 MPa, and time 10 seconds for main pressure bonding.

After pressure-bonding the flexible substrate (FPC), a resistance value between the external output terminal on the flexible substrate (FPC) side and the lead wire corresponding to the external output terminal was measured. The resistance value was measured for 2,500 external connection terminals, and a portion where the resistance value could not be measured (overload) was determined to be a connection portion with conduction failure; and a proportion of the number of conduction failures to all 2,500 connection portions was calculated as a FPC bondability NG rate at a level difference portion.

It was determined that sufficient manufacturing efficiency was obtained in a case where the FPC bondability NG rate at a level difference portion was 0.1% or less.

It was determined that sufficient manufacturing efficiency was not obtained in a case where the FPC bondability NG rate at a level difference portion was more than 0.1%.

The FPC bondability NG rate at a level difference portion was recorded as a conduction failure rate in Tables 1 and 2 below.

TABLE 1

| | Level 1 | Level 2 | Level 3 | Level 4 | Level 5 | Level 6 | Level 7 | Level 8 | Level 9 |
|---|---|---|---|---|---|---|---|---|---|
| Height A of lead | 1.5 | 1.5 | 1.5 | 2.0 | 1.5 | 1.05 | 1.35 | 1.95 | 1.5 |
| wire [μm] | | | | | | | | | |
| Height B of first | — | 1.0 | 1.0 | 2.0 | 1.0 | 1.0 | 1.0 | 1.0 | 1.45 |
| structure part [μm] | | | | | | | | | |
| Height C of second | 2.0 | — | 2.0 | 2.0 | 2.0 | 2.0 | 2.0 | 2.0 | 2.0 |
| structure part [μm] | | | | | | | | | |
| B < A < C | — | — | OK | NG | OK | OK | OK | OK | OK |
| A ÷ C | 0.75 | — | 0.75 | 1.00 | 0.75 | 0.53 | 0.68 | 0.98 | 0.75 |
| B ÷ C | — | — | 0.50 | 1.00 | 0.50 | 0.50 | 0.50 | 0.50 | 0.73 |
| Proportion of first | 0% | 100% | 50% | 50% | 50% | 50% | 50% | 50% | 50% |
| structure part in | | | | | | | | | |
| external connection | | | | | | | | | |
| terminal | | | | | | | | | |
| Proportion of | 100% | 0% | 50% | 50% | 50% | 50% | 50% | 50% | 50% |
| second structure part | | | | | | | | | |
| in external | | | | | | | | | |
| connection terminal | | | | | | | | | |
| Pattern of first | — | Rhombic | Solid | Rhombic | Rhombic | Rhombic | Rhombic | Rhombic | Rhombic |
| structure part | | mesh | | mesh | mesh | mesh | mesh | mesh | mesh |
| Pattern of second | Solid | — | Solid | Solid | Solid | Solid | Solid | Solid | Solid |
| structure part | | | | | | | | | |
| Opening ratio of | — | 84% | 0% | 84% | 84% | 84% | 84% | 84% | 84% |
| first structure part | | | | | | | | | |
| Opening ratio of | 0% | — | 0% | 0% | 0% | 0% | 0% | 0% | 0% |
| second structure part | | | | | | | | | |
| Spark resistance | 0.55% | 5.0% | 0.3% | 6.0% | 0.15% | 0.35% | 0.25% | 0.25% | 0.35% |
| (defective product | | | | | | | | | |
| rate) | | | | | | | | | |
| Conduction failure | 29.0% | 0.0% | 35.2% | 0.0% | 0.0% | 0.0% | 0.0% | 0.0% | 0.0% |
| rate | | | | | | | | | |

TABLE 2

| | Level | Level | Level | Level | Level | Level | Level | Level | Level |
|---|---|---|---|---|---|---|---|---|---|
| | 10 | 11 | 12 | 13 | 14 | 15 | 16 | 17 | 18 |
| Height A of lead wire [μm] | 1.5 | 1.35 | 1.95 | 1.95 | 1.5 | 1.5 | 1.5 | 1.5 | 1.5 |
| Height B of first structure | 0.45 | 0.45 | 0.45 | 1.45 | 1.0 | 1.0 | 1.0 | 1.0 | 1.0 |
| part [μm] | | | | | | | | | |
| Height C of second structure | 2.0 | 2.0 | 2.0 | 2.0 | 2.0 | 2.0 | 2.0 | 2.0 | 2.0 |
| part [μm] | | | | | | | | | |
| B < A < C | OK | OK | OK | OK | OK | OK | OK | OK | OK |
| A ÷ C | 0.75 | 0.68 | 0.98 | 0.98 | 0.75 | 0.75 | 0.75 | 0.75 | 0.75 |
| B ÷ C | 0.23 | 0.23 | 0.23 | 0.73 | 0.50 | 0.50 | 0.50 | 0.50 | 0.50 |
| Proportion of first structure | 50% | 50% | 50% | 50% | 24% | 75% | 50% | 50% | 50% |
| part in external connection | | | | | | | | | |
| terminal | | | | | | | | | |
| Proportion of | 50% | 50% | 50% | 50% | 76% | 25% | 50% | 50% | 50% |
| second structure | | | | | | | | | |
| part in external connection | | | | | | | | | |
| terminal | | | | | | | | | |
| Pattern of first structure | Rhombic | Rhombic | Rhombic | Rhombic | Rhombic | Rhombic | Rhombic | Rhombic | Rhombic |
| part | mesh | mesh | mesh | mesh | mesh | mesh | mesh | mesh | mesh + |
| | | | | | | | | | non- |
| | | | | | | | | | conductive |
| | | | | | | | | | portion |
| Pattern of second structure | Solid | Solid | Solid | Solid | Solid | Solid | Solid | Rhombic | Solid |
| part | | | | | | | | mesh | |
| Opening ratio of first | 84% | 84% | 84% | 84% | 84% | 50% | 77% | 84% | 67% |
| structure part | | | | | | | | | |
| Opening ratio of second | 0% | 0% | 0% | 0% | 0% | 0% | 0% | 56% | 0% |
| structure part | | | | | | | | | |
| Spark resistance (defective | 0.35% | 0.35% | 0.41% | 0.38% | 0.42% | 0.21% | 0.15% | 0.1% | 0.15% |
| product rate) | | | | | | | | | |
| Conduction failure rate | 0.0% | 0.0% | 0.0% | 0.0% | 0.0% | 0.0% | 0.0% | 0.0% | 0.0% |

As shown in Tables 1 and 2, among the above-described levels 1 to 18, the levels 5, 7, 8, 11, and 18 corresponding to Examples obtained sufficient manufacturing efficiency in terms of spark resistance, and sufficient manufacturing efficiency was also obtained in terms of bondability with the flexible substrate, as compared with the levels 1 to 4 corresponding to Comparative Examples.

The levels 6, 9, 10, and 13 to 17 corresponding to Examples obtained sufficient manufacturing efficiency in terms of spark resistance, and sufficient manufacturing efficiency was also obtained in terms of bondability with the flexible substrate, as compared with the levels 1 to 4 corresponding to Comparative Examples.

### EXPLANATION OF REFERENCES

10: image display device
11: touch panel
12: conductive member for touch panel
14: image display unit
14a: display surface
14b, 24b: back surface
15: first transparent insulation layer
16: cover part
16a, 24a: front surface
17: second transparent insulation layer
18: anisotropic conductive film
19: flexible substrate
20: detection unit
22: peripheral wiring part
23a: first lead wire
23b: second lead wire
24: substrate
26a: first external connection terminal
26b: second external connection terminal
29A: first detection electrode layer
29B: second detection electrode layer
30: first detection electrode
32: second detection electrode
35: metal wire
36, 45, 48, 53: opening portion
38: touch sensor film
40, 40a, 40b, 103: first structure part
42, 42a, 104: second structure part
43: wiring
44, 44a, 44b, 47: pattern
46: wiring
49: non-conductive portion
50: wiring
50a: first curve
50b: second curve
51a, 51b: top portion
52: contact point
60: stage
60a: front surface
62: adhesive sheet
63: adhesive layer
64: release paper
65: heating and pressing head
100, 101, 102: external connection terminal
D_{L}: extending direction
Da: first orientation
Db: second orientation
Ds: lamination direction
Dw: width direction
E₁: detection region
E₂: peripheral region
Lλ: distance
Wa: amplitude
α: angle

What is claimed is:

1. A conductive member for a touch panel, comprising:
a substrate; and
a conductive layer disposed on at least one surface of the substrate,
wherein the conductive layer includes a plurality of detection electrodes, a plurality of lead wires led out from the plurality of detection electrodes, and a plurality of external connection terminals connected to the plurality of lead wires,
the external connection terminal has a first structure part disposed on a lead wire side and a second structure part electrically connected to the first structure part,
the first structure part has a pattern formed by a wire which forms an angle with an extending direction of the external connection terminal, and
in a case where a height of the lead wire is indicated as A, a height of the first structure part is indicated as B, and a height of the second structure part is indicated as C, B<A<C is satisfied.

2. A conductive member for a touch panel, comprising:
a substrate; and
a conductive layer disposed on at least one surface of the substrate,
wherein the conductive layer includes a plurality of detection electrodes, a plurality of lead wires led out from the plurality of detection electrodes, and a plurality of external connection terminals connected to the plurality of lead wires,
the external connection terminal has a first structure part disposed on a lead wire side and a second structure part electrically connected to the first structure part,
the first structure part includes a plurality of wirings arranged side by side in a width direction orthogonal to an extending direction of the external connection terminal, each wiring having a first curve which protrudes to a first orientation in the width direction and a second curve which protrudes to a second orientation opposite to the first orientation, the curves being alternately arranged along the extending direction, and the wirings being in contact with adjacent wirings in the width direction, and
in a case where a height of the lead wire is indicated as A, a height of the first structure part is indicated as B, and a height of the second structure part is indicated as C, B<A<C is satisfied.

3. The conductive member for a touch panel according to claim 2,
wherein a first curve and a second curve of the first structure part are formed by a circular arc, a parabolic curve, or a curve represented by a periodic function.

4. The conductive member for a touch panel according to claim 1,
wherein the first structure part has a mesh-like wiring pattern.

5. The conductive member for a touch panel according to claim 1,
wherein the height A of the lead wire, the height B of the first structure part, and the height C of the second structure part satisfy 0.7<A/C<1.0 and 0.25<B/C<0.7.

6. The conductive member for a touch panel according to claim 1,
wherein a proportion of a length of the first structure part in the extending direction to a length of the external connection terminal in the extending direction is 25% or more.

7. A touch panel comprising:
the conductive member for a touch panel according to claim 1.

8. An image display device comprising:
the conductive member for a touch panel according to claim 1; and
an image display element.

9. The conductive member for a touch panel according to claim 2,
wherein the first structure part has a mesh-like wiring pattern.

10. The conductive member for a touch panel according to claim 3,
wherein the first structure part has a mesh-like wiring pattern.

11. The conductive member for a touch panel according to claim 2,
wherein the height A of the lead wire, the height B of the first structure part, and the height C of the second structure part satisfy 0.7<A/C<1.0 and 0.25<B/C<0.7.

12. The conductive member for a touch panel according to claim 3,
wherein the height A of the lead wire, the height B of the first structure part, and the height C of the second structure part satisfy 0.7<A/C<1.0 and 0.25<B/C<0.7.

13. The conductive member for a touch panel according to claim 2,
wherein a proportion of a length of the first structure part in the extending direction to a length of the external connection terminal in the extending direction is 25% or more.

14. The conductive member for a touch panel according to claim 3,
wherein a proportion of a length of the first structure part in the extending direction to a length of the external connection terminal in the extending direction is 25% or more.

15. A touch panel comprising:
the conductive member for a touch panel according to claim 2.

16. A touch panel comprising:
the conductive member for a touch panel according to claim 3.

17. An image display device comprising:
the conductive member for a touch panel according to claim 2; and
an image display element.

18. An image display device comprising:
the conductive member for a touch panel according to claim 3; and
an image display element.
